(19) United States
(12) Patent Application Publication
(10) Pub. No.: US 2026/0271097 A1
(43) Pub. Date: Sep. 10, 2026

(54) NON-PRIMARY CHANNEL ACCESS OPERATION

(71) Applicant: Ofinno, LLC, Reston, VA (US)

(72) Inventors: Jeongki Kim, Fairfax, VA (US); Leonardo Alisasis Lanante, Reston, VA (US); Esmael Hejazi Dinan, McLean, VA (US); Serhat Erkucuk, Reston, VA (US); Tuncer Baykas, Reston, VA (US); Jiayi Zhang, Rockville, MD (US)

(73) Assignee: Ofinno, LLC, Reston, VA (US)

(21) Appl. No.: 19/665,107

(22) Filed: May 1, 2026

Related U.S. Application Data
(63) Continuation of application No. PCT/US2024/054042, filed on Nov. 1, 2024.
(60) Provisional application No. 63/595,787, filed on Nov. 3, 2023.

(51) Int. Cl. H04W 74/08; H04W 28/02

(52) U.S. Cl. CPC H04W 74/0866; H04W 28/0268

(57) ABSTRACT

An access point (AP) transmits a first frame comprising a medium synchronization duration for a first channel. The AP receives, via a second channel, a second frame comprising a duration field indicating a first duration for transmission or reception of one or more frames on the second channel after the second frame. After receiving the second frame and during a medium synchronization duration for the first channel, the AP transmits, via the first channel, a third frame indicating a second duration overlapping with the first duration.

### CROSS-REFERENCE TO RELATED APPLICATIONS

This application is a continuation of International Application No. PCT/US2024/054042, filed Nov. 1, 2024, which claims the benefit of U.S. Provisional Application No. 63/595,787, filed Nov. 3, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example trigger frame.

FIG. 5 illustrates an example multi-user request to send (MU-RTS) trigger frame.

FIG. 6 illustrates an example common info field.

FIG. 7 illustrates an example of a Request-to-Send (RTS)/Clear-to-Send (CTS) procedure.

FIG. 8 illustrates an example of a wideband RTS/CTS procedure.

FIG. 9 illustrates an example of a wideband RTS/CTS procedure that uses a bandwidth signaling RTS frame.

FIG. 10 is an example that illustrates an MU-RTS/CTS procedure.

FIG. 11 is an example that illustrates existing multiple primary channel (MPC) STA operation.

FIG. 12 illustrates virtual and physical carrier sense (CS) functions associated with primary and secondary channels for an MPC STA and a non-MPC STA.

FIG. 13 is an example that contrasts the operation of a concurrent CCA MPC STA and the operation of a non-concurrent CCA MPC STA.

FIG. 14 is another example that contrasts the operation of a concurrent CCA MPC STA and the operation of a non-concurrent CCA MPC STA.

FIG. 15 illustrates an example procedure which may be performed by an AP according to an embodiment.

FIG. 16 illustrates another example procedure which may be performed by an AP according to an embodiment.

FIG. 17 illustrates another example procedure which may be performed by an AP according to an embodiment.

FIG. 18 illustrates an example procedure which may be performed by a non-concurrent CCA MPC STA according to an embodiment.

FIG. 19 illustrates an information element which may be used in embodiments.

FIG. 20 illustrates an inefficiency that may arise in the procedure of FIG. 15.

FIG. 21 illustrates an example procedure according to an embodiment.

FIG. 22 illustrates another example procedure according to an embodiment.

FIG. 23 illustrates another example procedure according to an embodiment.

FIG. 24 illustrates another example procedure according to an embodiment.

FIG. 25 illustrates an example process according to an embodiment.

FIG. 26 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAS, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

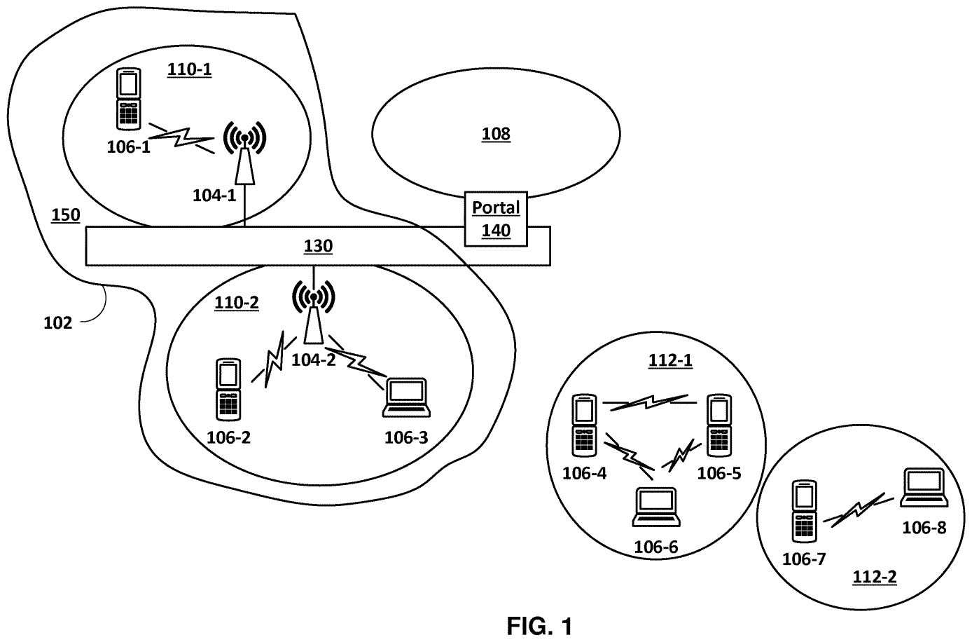

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

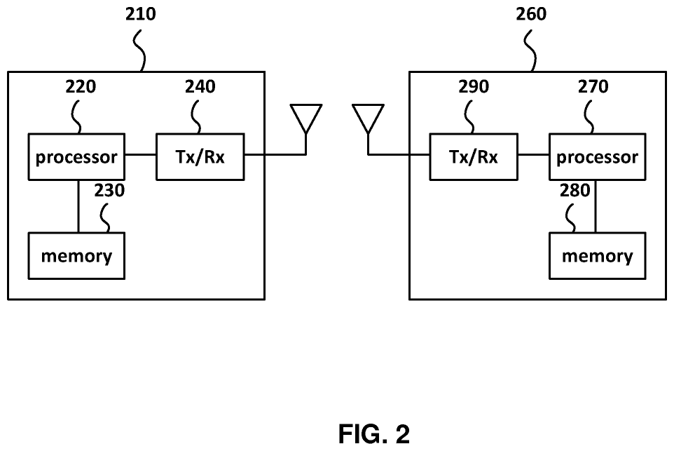

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

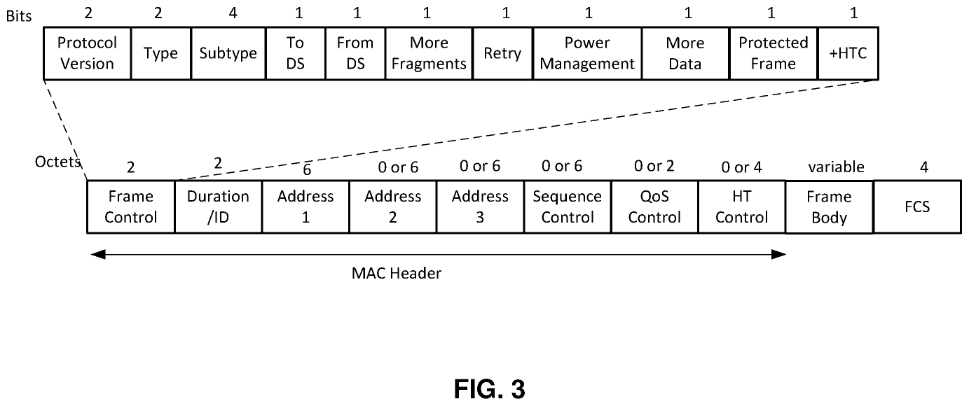

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

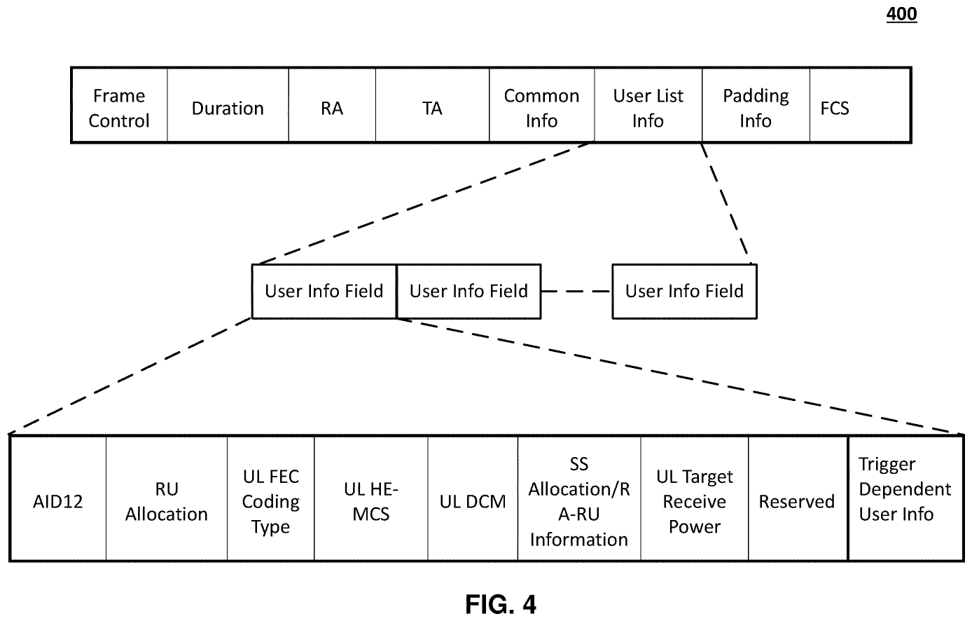

FIG. 4 illustrates an example trigger frame 400. Trigger frame 400 may correspond to a basic trigger frame as defined in the existing IEEE 802.11ax standard amendment. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if the trigger frame 400 is addressed to STAs from at least two different BSSs of the multiple BSSID set.

The common info field may have a format as illustrated by common info field 600 described further below. The common info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame.

The User List Info field contains a User Info field per STA addressed in trigger frame 400. The per STA User Info field includes, among others, an AID subfield, an RU Allocation subfield, a Spatial Stream (SS) Allocation subfield, an MCS subfield to be used by a STA in a TB PPDU transmitted in response to trigger frame 400, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 400 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

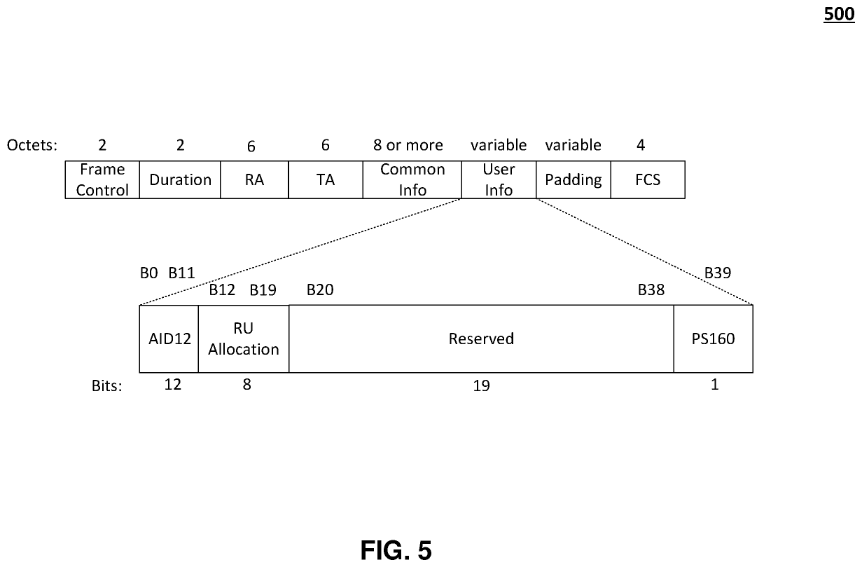

FIG. 5 illustrates an example multi-user request to send (MU-RTS) trigger frame 500. MU-RTS trigger frame 500 may be used by an AP to solicit simultaneous CTS frames from multiple STAs to transmit a downlink (DL) MU PPDU to the multiple STAs. As shown in FIG. 5, MU-RTS trigger frame 500 may comprise a frame control field, a duration field, an RA field, a TA field, a common info field, one or more user info fields, a padding field, and an FCS field. The frame control, TA, RA, padding, and FCS fields may be similar to the corresponding fields of trigger frame 400 described above. The common info field may have a format as illustrated by common info field 600 described further below. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 500. As shown in FIG. 5, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

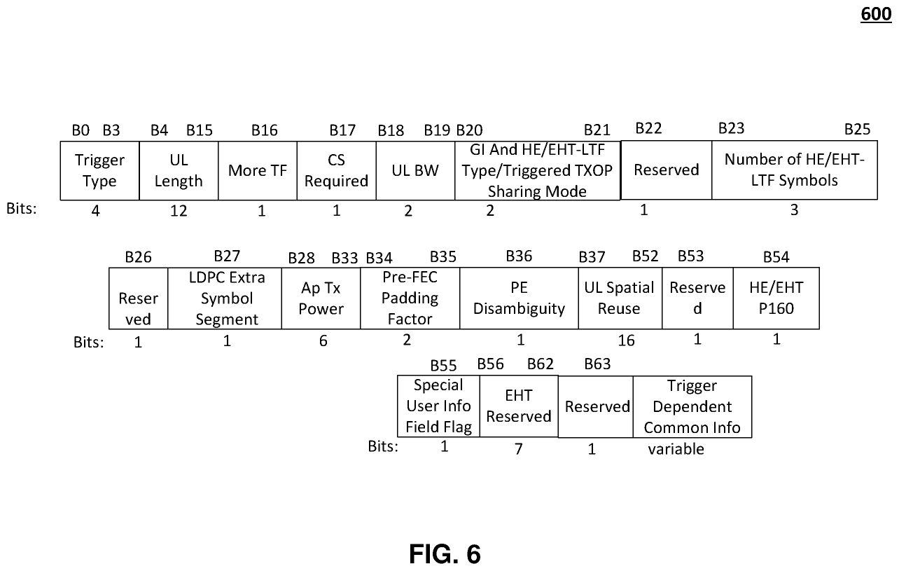

FIG. 6 illustrates an example Common Info field 600. Common Info field 600 may be an embodiment of the Common Info field of trigger frame 400 or MU-RTS trigger frame 500, for example. As shown in FIG. 6, Common Info field 600 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P802.11be/D3.1, March 2023”).

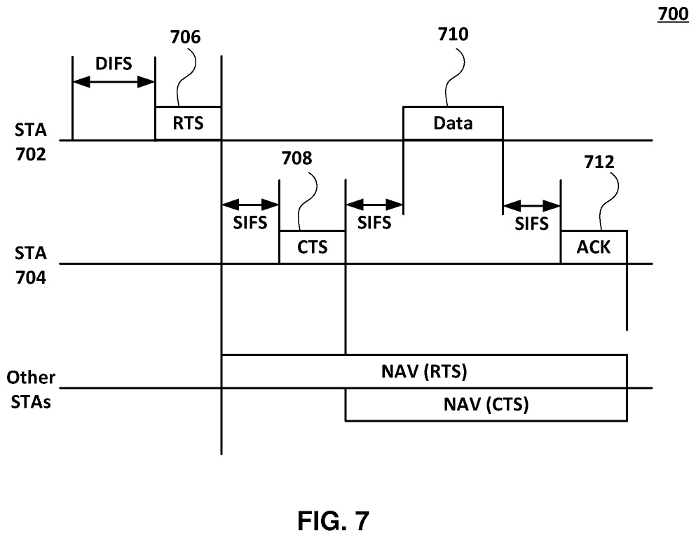

FIG. 7 illustrates an example 700 of a Request-to-Send (RTS)/Clear-to-Send (CTS) procedure. Example 700 may be an example according to the RTS/CTS procedure as defined in section 10.3.2.9 of the IEEE 802.11 standard draft “IEEE P802.11-REVme™/D3.0, April 2023.” As shown in FIG. 7, example 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

As shown in example 700, other STAs within communication range of STAs 702 and 704, and belonging to the same BSS, may set their NAVs according to RTS frame 706 and/or CTS frame 708. For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using EDCA until the end of transmission of ACK frame 712.

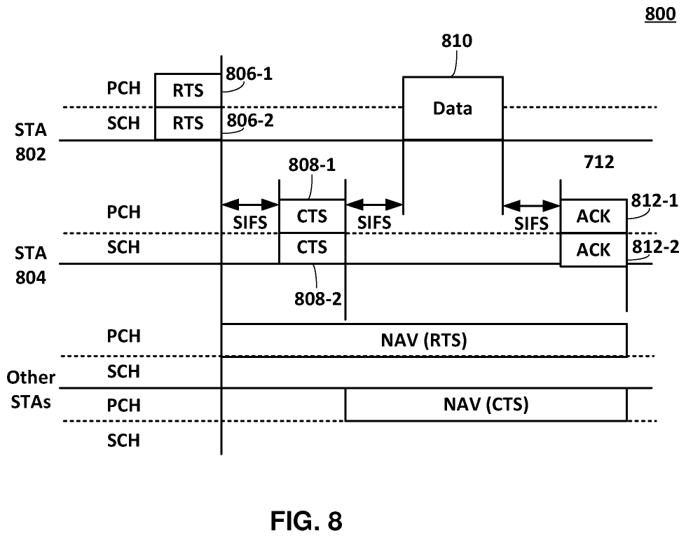

FIG. 8 illustrates an example 800 of a wideband RTS/CTS procedure. As shown in FIG. 8, example 800 may include STAs 802 and 804. Other STAs may also be within communication range of STAs 802 and 804. STAs 802 and 804 may each operate on a primary channel (PCH) and a secondary channel (SCH). For example, without limitation, the PCH may correspond to a primary 20 MHz channel and the SCH may correspond to a secondary 20 MHz channel.

Example 800 may begin with STA 802 accessing both the PCH and SCH to transmit simultaneously RTS frames 806-1 and 806-2 on the PCH and the SCH, respectively, to STA 804. In an example, RTS frames 806-1 and 806-2 may be transmitted in a non-HT duplicate PPDU having a bandwidth equal to the combined bandwidth of the PCH and the SCH (e.g., 40 MHz). In an implementation, before transmitting RTS frames 806-1 and 806-2, STA 802 may check a NAV associated with the PCH. If the NAV associated with the PCH indicates that the PCH is idle, STA 802 may perform a clear channel assessment (CCA) on the PCH and the SCH. The CCA may include determining whether a received signal energy on a channel exceeds an energy detect (ED) threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 802 may access both the PCH and the SCH to transmit RTS frames 806-1 and 806-2.

RTS frames 806-1 and 806-2 may be duplicate frames. RTS frames 806-1 and 806-2 may include a duration field indicating the time, in microseconds, required to transmit a data frame 810, plus one CTS frame, plus one Ack frame, plus three SIFSs.

On receiving RTS frames 806-1 and 806-2, other STAs within the communication range of STA 802 may set a NAV associated with the PCH based on RTS frame 806-1. In an implementation, the other STAs may not maintain a NAV for the SCH.

On receiving RTS frames 806-1 and 806-2, STA 804 responds to STA 802 by transmitting CTS frames 808-1 and 808-2 on the PCH and the SCH respectively. CTS frames 808-1 and 808-2 may be transmitted a SIFS after STA 804 receives RTS frames 806-1 and 806-2 respectively. In an implementation, STA 804 transmits CTS frames 808-1 and 808-2 on the PCH and the SCH respectively based on a NAV associated with the PCH indicating that the PCH is idle. In an implementation, STA 804 may not maintain a NAV for the SCH or may not check a NAV associated with the SCH before transmitting CTS frames 808-1 and 808-2.

On receiving CTS frames 808-1 and 808-2, other STAs within the communication range of STA 804 may set a NAV associated with the PCH based on CTS frame 808-1. In an implementation, the other STAs may not maintain a NAV for the SCH.

On receiving CTS frames 808-1 and 808-2, STA 802 may proceed to transmit data frame 810 on both the PCH and the SCH. Data frame 810 may be transmitted a SIFS after STA 802 receives CTS frames 808-1 and 808-2. In an implementation, STA 802 may proceed to transmit data frame 810 on both the PCH and the SCH on the sole condition of receiving CTS frame 808-1 on the PCH. That is, STA 802 may not be required to receive CTS frame 808-2 on the SCH to transmit data frame 810 on the SCH as well as the PCH.

In an implementation, STA 804 may acknowledge data frame 810 by transmitting ACK frames 812-1 and 812-2 on the PCH and the SCH, respectively. ACK frames 812-1 and 812-2 may be transmitted a SIFS after STA 804 receives data frame 810.

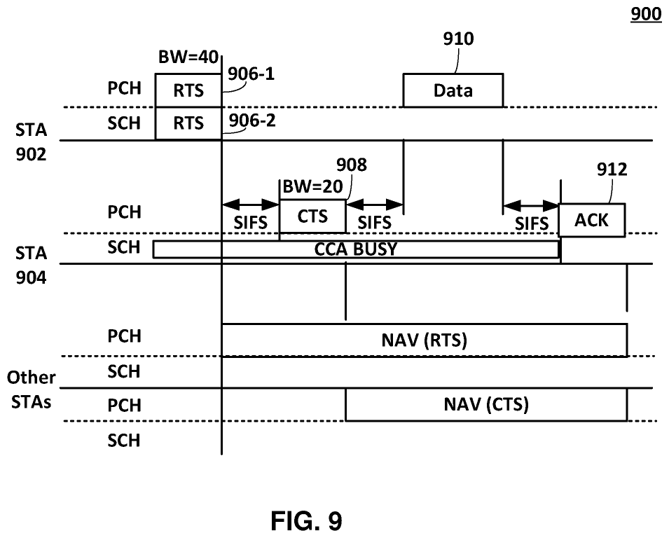

FIG. 9 illustrates an example 900 of a wideband RTS/CTS procedure that uses a bandwidth signaling RTS frame. As shown in FIG. 9, example 900 may include STAs 902 and 904. Other STAs may also be within communication range of STAs 902 and 904. STAs 902 and 904 may each operate on a primary channel (PCH) and a secondary channel (SCH). For example, without limitation, the PCH may correspond to a primary 20 MHz channel and the SCH may correspond to a secondary 20 MHz channel.

Example 900 may begin with STA 902 accessing both the PCH and SCH to transmit simultaneously RTS frames 906-1 and 906-2 on the PCH and the SCH, respectively, to STA 904. In an example, RTS frames 906-1 and 906-2 may be transmitted in a non-HT duplicate PPDU having a bandwidth equal to the combined bandwidth of the PCH and the SCH (e.g., 40 MHz). In an implementation, before transmitting RTS frames 906-1 and 906-2, STA 902 may check a NAV associated with the PCH. If the NAV associated with the PCH indicates that the PCH is idle, STA 902 may perform a CCA on the PCH and the SCH. The CCA may include determining whether a received signal energy on a channel exceeds an ED threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 902 may access both the PCH and the SCH to transmit RTS frames 906-1 and 906-2.

RTS frames 906-1 and 906-2 may be duplicate frames. RTS frames 906-1 and 906-2 may include a duration field indicating the time, in microseconds, required to transmit a data frame 910, plus one CTS frame, plus one Ack frame, plus three SIFSs.

In example 900, RTS frames 906-1 and 906-2 may be bandwidth signaling RTS frames. That is, RTS frames 906-1 and 906-2 may each include a field that indicates the bandwidth of the PPDU (e.g., 40 MHz) carrying RTS frames 906-1 and 906-2.

On receiving RTS frames 906-1 and 906-2, other STAs within the communication range of STA 902 may set a NAV associated with the PCH based on RTS frame 906-1. In an implementation, the other STAs may not maintain a NAV for the SCH.

On receiving RTS frames 906-1 and 906-2, STA 904 may decode the field indicating the bandwidth of the PPDU carrying RTS frames 906-1 and 906-2. The PPDU bandwidth may indicate to STA 904 that STA 902 wishes that STA 904 respond with CTS frames on both the PCH and the SCH. In an implementation, before responding to RTS frames 906-1 and 906-2, STA 904 may check a NAV associated with the PCH. In an implementation, STA 904 may not maintain a NAV for the SCH or may not check a NAV associated with the SCH before responding to RTS frames 906-1 and 906-2. In an implementation, if the NAV associated with the PCH indicates that the PCH is idle, STA 904 may perform a CCA on the PCH and the SCH. In an implementation, STA 904 may respond on both the PCH and the SCH if the CCA indicates “channel idle” on both the PCH and the SCH. In an implementation, STA 904 may respond on the PCH only if the CCA indicates “channel idle” on the PCH and “channel busy” on the SCH. In an implementation, STA 904 may not respond on the PCH or the SCH if the NAV associated with the PCH is non-zero.

In example 900, the CCA returns “channel idle” on the PCH and “channel busy” on the SCH. As such, STA 904 may transmit a CTS frame 908 only on the PCH. CTS frame 908 may thus have a bandwidth that is narrower than the PPDU bandwidth indicated in RTS frames 906-1 and 906-2. CTS frame 908 may be transmitted a SIFS after STA 904 receives RTS frames 906-1 and 906-2 respectively.

On receiving CTS frame 908, other STAs within the communication range of STA 904 may set a NAV associated with the PCH based on CTS frame 908.

On receiving CTS frame 908, STA 902 may proceed to transmit data frame 910 on the PCH. Data frame 910 may be transmitted a SIFS after STA 902 receives CTS frame 908. In an implementation, STA 904 may acknowledge data frame 910 by transmitting an ACK frame 912 on the PCH. ACK frame 912 may be transmitted a SIFS after STA 904 receives data frame 910.

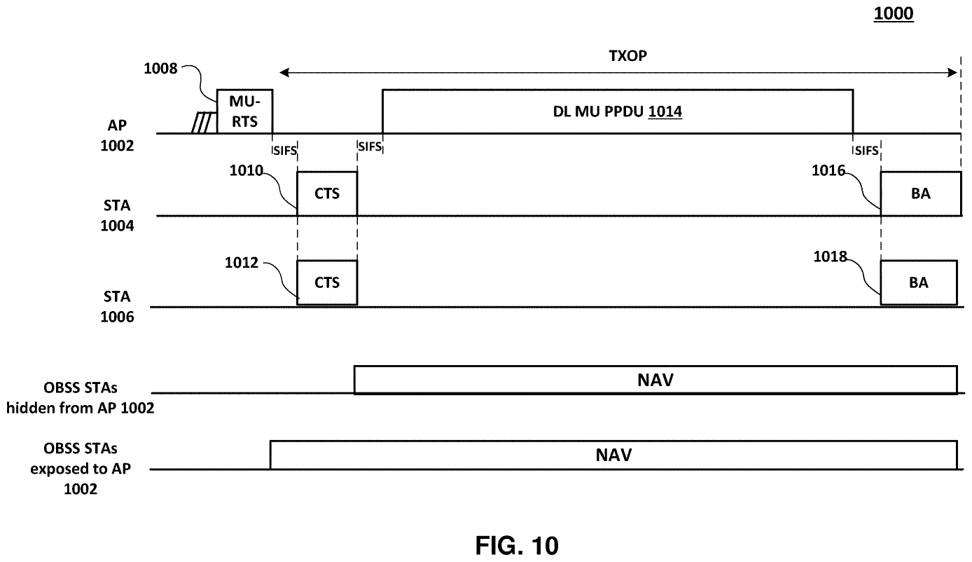

FIG. 10 is an example 1000 that illustrates a multi-user Request-to-Send (MU-RTS)/Clear-to-Send (CTS) procedure. Example 1000 may be an example according to the MU-RTS/CTS procedure as defined in section 26.2.6 of the IEEE 802.11 standard draft (“IEEE P802.11-REVme™/D3.0, April 2023”). As shown in FIG. 10, example 1000 may include an AP 1002 and STAs 1004 and 1006. STAs 1004 and 1006 may be associated with AP 1002. For the purpose of illustration, example 1000 also illustrates STAs of an overlapping basic service set (OBSS) relative to the BSS of AP 1002 (OBSS STAs). The OBSS STAs, as shown in FIG. 10, may be hidden from AP 1002 (outside of the communication range of AP 1002) or exposed to AP 1002 (within the communication range of AP 1002).

In example 1000, AP 1002 wishes to transmit a downlink (DL) multi-user (MU) PPDU 1014 to STAs 1004 and 1006. DL MU PPDU 1014 may comprise data for each of STAs 1004 and 1006. DL MU PPDU 1014 may occupy a plurality of channels (e.g., 20 MHz channels). Each channel of the plurality of channels may carry the data for a respective STA (e.g., STA 1004, STA 1006) served by DL MU PPDU 1014.

As shown in FIG. 10, to protect the transmission of DL MU PPDU 1014 to STAs 1004 and 1006 from interference by OBSS STAs hidden from AP 1002, AP 1002 may use the MU-RTS/CTS procedure to initiate a TXOP and to protect the TXOP frame exchange sequence. AP 1002 may initiate the TXOP by transmitting an MU-RTS trigger frame 1008 that solicits simultaneous CTS frame transmissions from STAs 1004 and 1006.

MU-RTS trigger frame 1008 may have a format as illustrated by MU-RTS trigger frame 500 illustrated in FIG. 5. As such, MU-RTS trigger frame 1008 may comprise a frame control field, a duration field, an RA field, a TA field, a common info field, one or more user info fields, a padding field, and an FCS field. The duration field may be set to the time, in microseconds, required to transmit DL MU PPDU 1014, plus the time required to transmit one CTS frame, one ACK frame (if required), and three SIFS periods.

The one or more user info fields correspond respectively to the one or more STAs solicited by the MU-RTS trigger frame. In example 1000, MU-RTS trigger frame 1008 may comprise a user info field for each of STAs 1004 and 1006 indicating that a CTS frame is solicited from each of STAs 1004 and 1006. As shown in FIG. 8, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

AP 1002 may send MU-RTS trigger frame 1008 in a PPDU that occupies one or more channels (e.g., 20 MHz channels). In an example, for each channel occupied by the PPDU that carries MU-RTS trigger frame 1008, AP 1002 may request at least one non-AP STA to send a CTS frame that occupies that channel. In an example, AP 1002 may not request that a non-AP STA send a CTS frame that occupies a channel that is not occupied by the PPDU carrying MU-RTS trigger frame 1008.

After transmitting MU-RTS trigger frame 1008, AP 1002 may wait for a CTSTimeout interval of aSIFSTime+aSlotTime+aRxPHYStartDelay that begins when a MAC layer of AP 1002 receives a PHYTXEND.confirm primitive for transmitted MU-RTS trigger frame 1008. If the MAC layer does not receive a PHY-RXEARLYSIG.indication or a PHY-RXSTART.indication primitive during the CTSTimeout interval, AP 1002 may conclude that the transmission of MU-RTS trigger frame 1008 has failed, and, if MU-RTS trigger frame 1008 initiated a TXOP, AP 1002 may invoke its backoff procedure. If the MAC layer receives a PHY-RXEARLYSIG.indication or a PHY-RXSTART.indication primitive during the CTSTimeout interval, then the MAC layer may wait for the corresponding PHY-RXEND.indication primitive to determine whether transmission of MU-RTS trigger frame 1008 was successful. The receipt of a CTS frame from any non-AP STA addressed by MU-RTS trigger frame 1008 before the PHY-RXEND.indication primitive shall be interpreted as the successful transmission of MU-RTS trigger frame 1008, permitting the frame exchange sequence to continue. The receipt of any other type of frame shall be interpreted as a failure of the transmission of MU-RTS trigger frame 1008. AP 1002 may process the received frame and, if MU-RTS trigger frame 1008 initiated a TXOP, AP 1002 shall invoke its backoff procedure at the PHY-RXEND.indication primitive.

In example 1000, on receiving MU-RTS trigger frame 1008, STAs 1004 and 1006 respond by transmitting respectively CTS frames 1010 and 1012 to AP 1002. In an example, STAs 1004 and 1006 begin the transmission of CTS frames 1010 and 1012, respectively, at the SIFS time boundary after an end of a received PPDU comprising MU-RTS trigger frame 1008. In an example, STA 1004 (or STA 1006) responds to MU-RTS trigger frame 1008 with a CTS frame when the following conditions are met: MU-RTS trigger frame 1008 comprises a user info field addressed to the STA (the AID12 subfield of the user info field is equal to the 12 LSBs of the AID of the STA) and MU-RTS trigger frame 1008 is sent by an AP with which the STA is associated; and the UL MU CS condition indicates that the medium is idle as described in section 26.5.2.5 (UL MU CS mechanism) of the IEEE 802.11 standard (“IEEE P802.11-REVme™/D3.0, April 2023”). Otherwise, if one of the conditions is not met, STA 1004 (or STA 1006) does not send a CTS frame to AP 1002.

In an example, STAs 1004 and 1006 may set an RA field of respectively CTS frames 1010 and 1012 to a TA obtained from the TA field of MU-RTS trigger frame 1008. In an example, STAs 1004 and 1006 may set a duration field of respectively CTS frames 1010 and 1012 based on the duration field of MU-RTS trigger frame 1008, namely as equal to the value of the duration field of MU-RTS trigger frame 1008, adjusted by subtracting the time required to transmit respectively CTS frames 1010 and 1012 and one SIFS period.

OBSS STAs exposed to AP 1002 may receive MU-RTS trigger frame 1008 due to being within the communication range of AP 1002. In an example, as shown in FIG. 10, on receiving MU-RTS trigger frame 1008, OBSS STAs exposed to AP 1002 set their respective NAVs based on the duration field of MU-RTS trigger frame 1008. As such, the OBSS STAs exposed to AP 1002 may not access the wireless medium for the duration of the TXOP initiated by AP 1002.

OBSS STAs hidden from AP 1002 do not receive MU-RTS trigger frame 1008 due to being outside the communication range of AP 1002. However, in an example, as shown in FIG. 10, some of the OBSS STAs hidden from AP 1002 may receive CTS frame 1010 and/or CTS frame 1012 and may set their respective NAVs based on the duration field of CTS frame 1010 and/or CTS frame 1012. As such, some of the OBSS STAs hidden from AP 1002 may also not access the wireless medium for the duration of the TXOP initiated by AP 1002.

On receiving CTS frame 1010 and/or CTS frame 1012, AP 1002 may wait one SIFS period before transmitting DL MU PPDU 1014. On receiving DL MU PPDU 1014, STAs 1004 and 1006 may respond by transmitting respective BlockAck (BA) frames 1016 and 1018 to AP 1002.

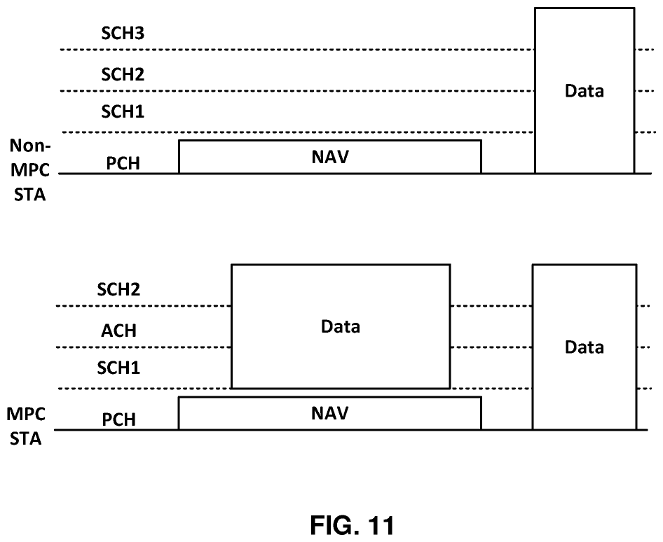

It is envisioned in future IEEE 802.11 standards that a STA may operate with multiple primary channels. Such a STA may be referred to as a multiple primary channel STA (MPC STA). Specifically, in addition to a default primary channel (which is used by all STAs in the BSS), an MPC STA may have one or more secondary channels considered as primary channels. Hereinafter, the default primary channel is referred to as “primary channel” and secondary channel(s) considered as primary channel(s) are referred to as anchor channel(s) (or auxiliary primary channel(s). The MPC STA may transmit or receive on a channel that includes such anchor channel(s) but that does not necessarily include the primary channel (e.g., when the primary channel is unavailable). An MPC STA may maintain a NAV for an anchor channel independent of the NAV associated with the primary channel. FIG. 11 is an example 1100 that illustrates an existing MPC STA operation mode. For the purpose of illustration, MPC STA operation is contrasted with single primary channel STA (non-MPC STA) operation. As shown in FIG. 11, the non-MPC STA may be capable of operating over a plurality of channels, including a primary channel (PCH), a first secondary channel (SCH1), a second secondary channel (SCH2), and a third secondary channel (SCH3). In an example, the channel corresponding to the second secondary channel (SCH2) of the non-MPC STA may correspond to an anchor channel (ACH) of the MPC STA, and the channel corresponding to the third secondary channel (SCH3) of the non-MPC STA may correspond to a second secondary channel (SCH2) of the MPC STA. The primary channel (PCH) and the first secondary channel (SCH1) of the non-MPC STA and the MPC STA correspond to the same channels. Among these channels, the non-MPC STA supports a single primary channel (i.e., PCH), whereas the MPC STA supports two primary channels (PCH and ACH).

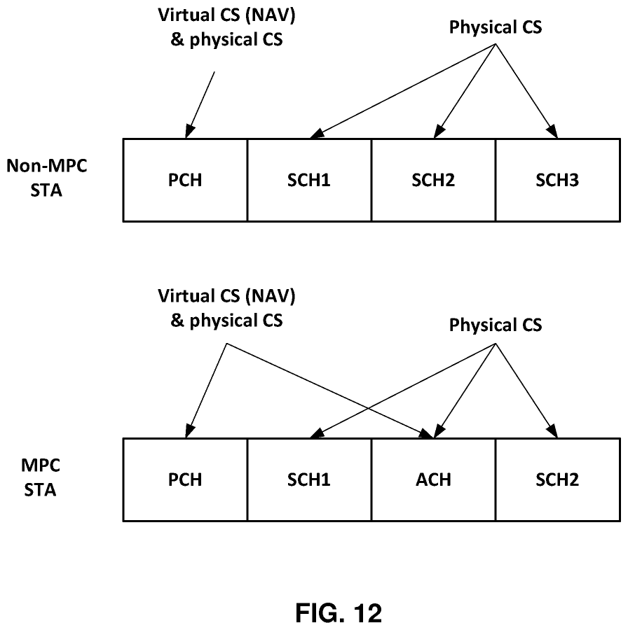

In an implementation, as shown in FIG. 12, in non-MPC STA operation, a virtual carrier sense (CS) function (e.g., NAV) may be associated with only the PCH. Secondary channels may have only a physical CS function (e.g., energy detection) associated with them, which may be performed only when contending for transmission on the PCH. As such, as shown in FIG. 11, a non-MPC STA may only transmit on a channel that includes the PCH (e.g., PCH, PCH+SCH1, PCH+SCH1+SCH2, PCH+SCH1+SCH2+SCH3) and only when the NAV associated with the PCH is zero (and the physical CS function indicates “channel idle” for all channels being used).

In contrast, as shown in FIG. 12, in MPC STA operation, a virtual CS function (e.g., NAV) may be associated with multiple channels (e.g., PCH and ACH). As such, as shown in FIG. 11, an MPC STA may transmit on channels that do not include the PCH but that include the ACH (e.g., ACH, ACH+SCH1, ACH+SCH2) if the NAV associated with the ACH is zero (and the physical CS indicates “channel idle” for all channels being used). In an implementation, an MPC STA may also transmit on channels that do not include the PCH but that include the ACH (e.g., ACH, ACH+SCH1, ACH+SCH2) if the MPC STA detects that the ACH is idle using physical CS for at least a medium synchronization duration.

In implementations, an MPC STA may perform physical and/or virtual CS functions (herein referred to as CS or CCA) on multiple channels (e.g., PCH and ACH). If the PCH is busy (non-zero NAV or CCA indicates “channel busy”), the MPC STA may use the ACH for transmission if the ACH is idle (zero NAV and CCA indicates “channel idle”).

In an implementation, an MPC STA may perform CS in parallel on multiple channels, including the PCH and the ACH. Such a STA is referred to herein as a concurrent CCA MPC STA (such a STA may also be referred to as a concurrent CCA non-primary channel access (NPCA) STA or a Type 1 STA). Because of its concurrent CCA capability, a concurrent CCA MPC STA is capable of medium synchronization simultaneously on multiple channels (e.g., PCH and ACH). Medium synchronization on a channel (e.g., PCH or ACH) may be performed by detecting a frame that includes NAV information or by listening to the channel for at least a medium synchronization duration and finding the channel idle throughout the medium synchronization duration. An MPC STA that does not support this capability may perform CS on a single channel at a time. In an implementation, an MPC STA may perform CS on the PCH by default, and when the PCH is found busy, the STA may perform CS on the ACH. Such a STA is referred to herein as a non-concurrent CCA MPC STA (such a STA may also be referred to as a non-concurrent CCA MPCA STA or a Type 2 STA). In contrast to the concurrent CCA MPC STA, a non-concurrent CCA MPC STA may only synchronize to the ACH after the PCH is found busy. Hence, it may need to listen to the channel for at least a medium synchronization duration (if it does not receive any frame that includes NAV information) before it is able to transmit.

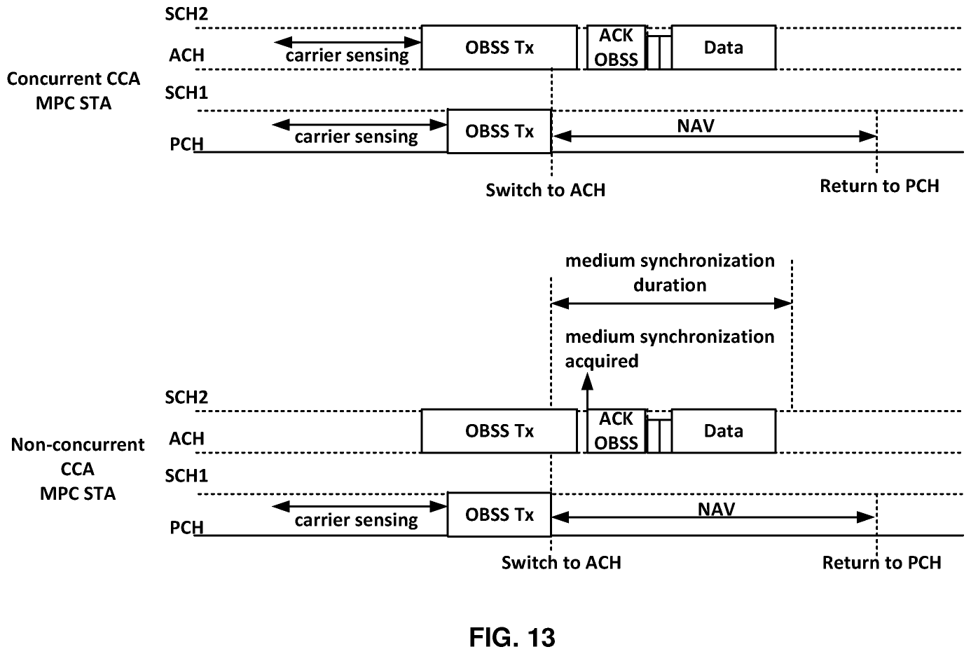

FIG. 13 is an example that contrasts the operation of a concurrent CCA MPC STA and the operation of a non-concurrent CCA MPC STA. As shown in FIG. 13, both the concurrent CCA MPC STA and the non-concurrent MPC STA may operate over a plurality of channels, including a primary channel (PCH), a first secondary channel (SCH1), an anchor channel (ACH), and a second secondary channel (SCH2). The concurrent CCA MPC STA may perform concurrent CS on the PCH and the ACH. The non-concurrent CCA MPC STA may perform CS on the PCH only.

The example of FIG. 13 may begin with the concurrent CCA MPC STA or the non-concurrent CCA MPC STA operating on the PCH. In an example, a first OBSS transmission may begin on the PCH. As both the concurrent CCA MPC STA and the non-concurrent CCA MPC STA perform CS on the PCH, both may detect the first OBSS transmission. In an implementation, on detecting the first OBSS transmission on the PCH, the concurrent CCA MPC STA and the non-concurrent CCA MPC STA may both be configured to set a NAV associated with the PCH (based on a duration of the first OBSS transmission) and to switch to the ACH for the duration of the NAV.

In an example, before or during the first OBSS transmission on the PCH, a second OBSS transmission may begin on the ACH. Having concurrent CS capability, the concurrent CCA MPC STA may detect the second OBSS transmission before switching to the ACH. In an implementation, the concurrent CCA MPC STA may set a NAV associated with the ACH based on the second OBSS transmission. The concurrent CCA MPC STA may wait until an end of the second OBSS transmission (and any associated ACK frames) before attempting to access the ACH to transmit a data frame. The concurrent CCA MPC STA may perform a random backoff before transmitting the data frame on the ACH. The concurrent CCA MPC STA may switch back to the PCH when the NAV associated with the PCH reaches zero.

In contrast, the non-concurrent CCA MPC STA may not detect the second OBSS transmission before switching to the ACH. On switching to the ACH, the non-concurrent CCA MPC STA may thus not be aware of the second OBSS transmission being transmitted on the ACH. At the same time, the non-concurrent CCA MPC STA may not have knowledge of a future time at which it may access the ACH. In an implementation, the non-concurrent MPC STA may be configured to wait for at least a medium synchronization duration for the ACH, after switching to the ACH, before attempting to access the ACH, unless a transmission is detected by the STA during the medium synchronization duration.

In an implementation, the non-concurrent MPC STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 13, the non-concurrent CCA MPC STA may detect and receive an ACK frame associated with the second OBSS transmission, after switching to the ACH. Reception of the ACK frame allows the non-concurrent CCA MPC STA to reset the “MediumSyncDelay” timer to zero and to acquire medium synchronization on the ACH. The non-concurrent CCA MPC STA may wait for an end of the ACK frame before performing a random backoff to transmit a data frame on the ACH. The non-concurrent CCA MPC STA may switch back to the PCH when the NAV associated with the PCH reaches zero.

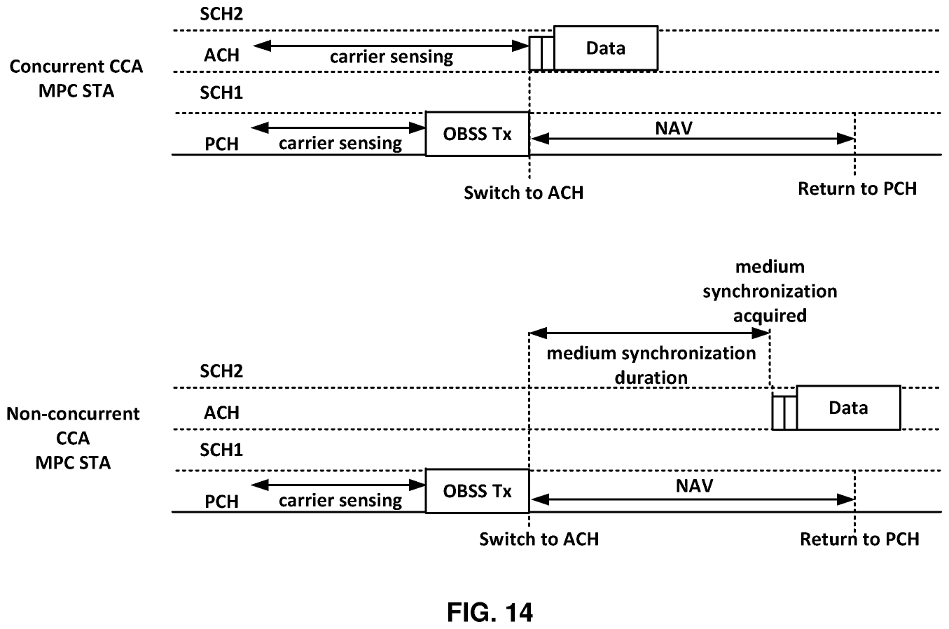

FIG. 14 is another example that contrasts the operation of a concurrent CCA MPC STA and the operation of a non-concurrent CCA MPC STA. As in the example of FIG. 13, both the concurrent CCA MPC STA and the non-concurrent MPC STA may operate over a plurality of channels, including a primary channel (PCH), a first secondary channel (SCH1), an anchor channel (ACH), and a second secondary channel (SCH2). The concurrent CCA MPC STA may perform concurrent CS on the PCH and the ACH. The non-concurrent CCA MPC STA may perform CS on the PCH only.

The example of FIG. 14 may begin with the concurrent CCA MPC STA or the non-concurrent CCA MPC STA operating on the PCH. In an example, a first OBSS transmission may begin on the PCH. As both the concurrent CCA MPC STA and the non-concurrent CCA MPC STA perform CS on the PCH, both may detect the first OBSS transmission. In an implementation, on detecting the first OBSS transmission on the PCH, the concurrent CCA MPC STA and the non-concurrent CCA MPC STA may both be configured to set a NAV associated with the PCH (based on a duration of the first OBSS transmission) and to switch to the ACH for the duration of the NAV.

In an example, the ACH may be idle at the time that the concurrent CCA MPC STA or the non-concurrent CCA MPC STA switches to the ACH. Having concurrent CS capability, the concurrent CCA MPC STA may be aware that the ACH is idle when the concurrent CCA MPC STA switches to the ACH. The concurrent CCA MPC STA may thus attempt to access the ACH immediately after switching to the ACH. As shown in FIG. 14, the concurrent CCA may perform a random backoff before transmitting a data frame on the ACH. The concurrent CCA MPC STA may switch back to the PCH when the NAV associated with the PCH reaches zero.

In contrast, on switching to the ACH, the non-concurrent CCA MPC STA may not have knowledge of whether the ACH is idle or busy. In an implementation, the non-concurrent MPC STA may be configured to wait for at least a medium synchronization duration for the ACH, after switching to the ACH, before attempting to access the ACH, unless a transmission is detected by the STA during the medium synchronization duration. In an implementation, the non-concurrent MPC STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 14, the non-concurrent CCA MPC STA may not detect or receive any frame during the medium synchronization duration. The non-concurrent CCA MPC STA may thus not reset the “Medium SyncDelay” timer to zero. The non-concurrent CCA MPC STA may only acquire medium synchronization on the ACH after the entire medium synchronization duration has elapsed. The non-concurrent CCA MPC STA may thus have to wait for the entirety of the medium synchronization duration before attempting to access the ACH. This is despite the fact that the ACH is idle and available for use during the medium synchronization duration. Buffered data at the non-concurrent CCA MPC STA may thus be delayed unnecessarily and the ACH may thus be under-utilized.

Embodiments of the present disclosure, as further described below, address the above-described problem. In an aspect, an AP may transmit a first frame comprising a medium synchronization duration for a first channel. The first channel may be an anchor channel or an auxiliary primary channel. When the medium synchronization duration for the first channel starts, the AP may transmit a second frame via the first channel. The medium synchronization duration for the first channel may start when the AP receives a third frame indicating a transmission on a second channel. The transmission may be an OBSS transmission. The transmission may cause the AP to switch from the second channel to the first channel. The second channel may be a primary channel of the AP. The second frame may be transmitted during the medium synchronization duration for the first channel. The second frame allows a non-concurrent CCA MPC STA to acquire medium synchronization on the first channel, without waiting for the entirety of the medium synchronization duration for the first channel.

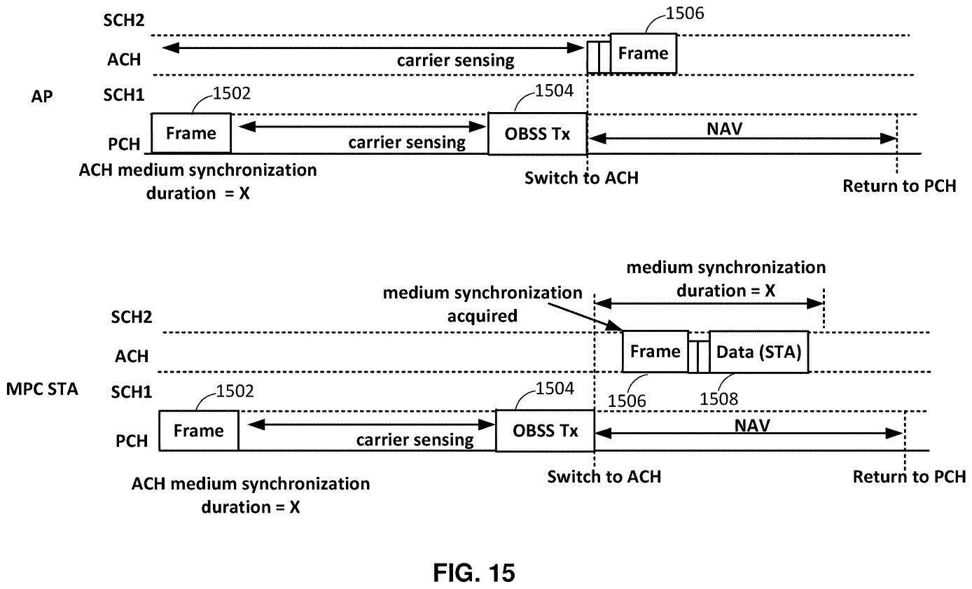

FIG. 15 illustrates an example procedure which may be performed by an AP according to an embodiment. For illustration, FIG. 15 also shows the behavior of a STA, which may be associated with the AP, in response to the example AP procedure. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH. The AP may support an anchor/auxiliary primary channel medium synchronization assistance mode, which allows the AP to perform the procedure of FIG. 15.

As shown in FIG. 15, the example procedure may begin with the AP operating on the PCH. In an example, the AP may transmit a frame 1502 on the PCH. Frame 1502 may be a management frame, such as a beacon frame. In an embodiment, frame 1502 may indicate the PCH and the ACH. In an embodiment, frame 1502 may comprise or indicate a medium synchronization duration for the ACH. In an embodiment, frame 1502 may comprise an indication of support by the AP of the anchor/auxiliary primary channel medium synchronization assistance mode. In an embodiment, frame 1502 may further comprise an indication of activation/deactivation of the anchor/auxiliary primary channel medium synchronization assistance mode by the AP. A STA associated with the AP may operate on the same channel as the AP. The STA may thus receive frame 1502 via the PCH.

In an example, while the AP is operating on the PCH, transmission of a frame 1504 from an OBSS may begin on the PCH. The AP may detect frame 1504 on the PCH. In an implementation, the AP may be configured to set a NAV associated with the PCH based on receiving frame 1504 on the PCH. Frame 1504 may indicate a transmission on the PCH. A duration of the transmission on the PCH may be provided by a duration field of frame 1504, a transmission opportunity (TXOP) duration field of a PPDU comprising frame 1504, or a length field of the PPDU. In an implementation, the AP may be configured to switch to the ACH for the NAV duration. In an embodiment, the AP may start a “MediumSyncDelay” timer for the medium synchronization duration of the ACH, after switching to the ACH. The “MediumSyncDelay” timer may be set based on the medium synchronization duration for the ACH indicated in frame 1504.

In an embodiment, after switching to the ACH, the AP may be configured to transmit a frame 1506 on the ACH during the medium synchronization duration for the ACH. In an implementation, the AP may be capable of concurrent CS on the PCH and the ACH. Thus, as shown in FIG. 15, the AP may transmit frame 1506 on the ACH (after performing a random backoff) without waiting for expiration of the medium synchronization duration for the ACH. Frame 1506 may be any frame, including a CTS frame, a contention free (CF) end frame, a trigger frame, a QoS data/null frame, or a null data packet (NDP) frame.

In an implementation, the AP may determine a CCA state of the ACH before transmitting frame 1506. In an implementation, the AP may transmit frame 1506 on condition of the CCA state of the ACH being idle. In an implementation, the AP may transmit frame 1506 on condition of the CCA state of the ACH being idle for a first duration before the AP receives frame 1504 on the PCH. In an implementation, the CCA state of the ACH being idle comprises a received power measured by the AP on the ACH, during the first duration, being less than a threshold. The first duration may be one of 5.484 milliseconds, 25 microseconds, or 16 microseconds, for example. The threshold may be one of −62 dBm, −72 dBm, or −82 dBm, for example. In an embodiment, the CCA state of the ACH being idle comprises a NAV associated with the ACH being equal to zero.

In an embodiment, the AP may transmit frame 1506 on the ACH on condition of a backoff count associated with the ACH being zero. The backoff count may be initialized to a random number by the AP. The backoff count may be initialized by the AP after an end of a PPDU carrying frame 1504 on the PCH; an indication of a successful preamble detection; or an indication of a successful MPDU detection on the PCH.

A STA associated with the AP may also detect and receive frame 1504 on the PCH. Like the AP, the STA may be configured to set a NAV associated with the PCH based on receiving frame 1504 on the PCH. In an implementation, the STA may also be configured to switch to the ACH for the NAV duration along with the AP. In an implementation, the STA may be configured to switch to the ACH when the STA is an MPC STA. In an embodiment, the STA may start a “MediumSyncDelay” timer for the medium synchronization duration of the ACH, after switching to the ACH. The “MediumSyncDelay” timer may be set based on the medium synchronization duration for the ACH indicated in frame 1502.

In an example, as shown in FIG. 15, the STA may be a non-concurrent CCA MPC STA. On switching to the ACH, the STA may not be aware of whether a transmission is taking place on the ACH. The STA may be configured to wait for the “MediumSyncDelay” timer to expire before attempting to access the ACH. The transmission by the AP of frame 1506, however, allows the non-concurrent CCA MPC STA to acquire medium synchronization on the ACH. Specifically, on receiving frame 1506, the STA may reset the “MediumSyncDelay” timer to zero. The STA may then proceed to access the ACH, after performing a random backoff, to transmit a frame 1508 on the ACH. Frame 1508 may be a QoS data/null frame, for example. In an example, frame 1508 may be in response to frame 1506. For example, frame 1506 may be a trigger frame that triggers transmission of frame 1508 by the STA.

In an embodiment, the STA may transmit frame 1508 on the ACH on condition of a backoff count associated with the ACH being zero. The backoff count may be initialized to a random number by the STA. The backoff count may be initialized by the STA after an end of a PPDU carrying frame 1504 on the PCH; an indication of a successful preamble detection; or an indication of a successful MPDU detection on the PCH.

In another embodiment, the STA may be a concurrent CCA MPC STA. The STA may be capable of concurrent CS on the PCH and the ACH. In an implementation, the STA may determine a CCA state of the ACH. A CCA state may include a physical CS state and a virtual CS state. The CCA state may be considered idle when both the physical CS state and the virtual CS state indicate that the channel is idle. In an embodiment, the STA may transmit frame 1506 (e.g., together or in place of the AP) on condition of the CCA state of the ACH being idle. In an implementation, the STA may transmit frame 1506 on condition that the anchor/auxiliary primary channel medium synchronization assistance mode is activated by the AP. In an implementation, the STA may transmit frame 1506 on condition of the CCA state of the ACH being idle for a first duration before the STA receives frame 1504 on the PCH. In an implementation, the CCA state of the ACH being idle comprises a received power measured by the STA on the ACH, during the first duration, being less than a threshold. The first duration may be one of 5.484 milliseconds, 25 microseconds, or 16 microseconds, for example. The threshold may be one of −62 dBm, −72 dBm, or −82 dBm, for example. In an embodiment, the CCA state of the ACH being idle comprises a NAV associated with the ACH being equal to zero.

In an embodiment, the STA may transmit frame 1506 on the ACH on condition of a backoff count associated with the ACH being zero. The backoff count may be initialized to a random number by the STA. The backoff count may be initialized by the STA after an end of a PPDU carrying frame 1504 on the PCH; an indication of a successful preamble detection; or an indication of a successful MPDU detection on the PCH.

In an embodiment, the STA transmits frame 1506 simultaneously with the AP. In this embodiment, frame 1506 may be of a specific frame type that is known to both AP and STA. In this embodiment, the backoff count associated with the ACH may be initialized to a value that is known to both AP and STA (e.g., 0).

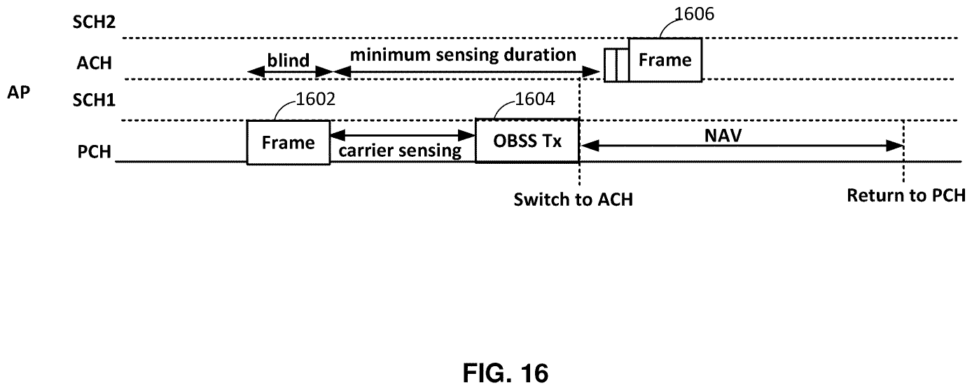

FIG. 16 illustrates another example procedure which may be performed by an AP according to an embodiment. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH. The AP may support an anchor/auxiliary primary channel medium synchronization assistance mode, which allows the AP to perform the procedure of FIG. 16. The example procedure of FIG. 16 may be used independently or in combination with the procedure of FIG. 15.

As shown in FIG. 16, the example procedure may begin with the AP operating on the PCH. In an example, the AP may transmit a frame 1602 on the PCH. Frame 1602 may be any frame, including a data frame, a control frame, or a management frame. In an implementation, at the time of transmitting frame 1602 on the PCH, the AP may not be capable of performing CS on the ACH. The AP may thus not be able to monitor the ACH for transmissions while transmitting frame 1602 on the PCH.

In an example, after the AP transmits frame 1602 on the PCH, transmission of a frame 1604 from an OBSS may begin on the PCH. The AP may detect frame 1604 on the PCH. In an implementation, the AP may be configured to set a NAV associated with the PCH based on receiving frame 1604 on the PCH. Frame 1604 may indicate a transmission on the PCH. A duration of the transmission on the PCH may be provided by a duration field of frame 1604, a transmission opportunity (TXOP) duration field of a PPDU comprising frame 1604, or a length field of the PPDU. In an implementation, the AP may be configured to switch to the ACH for the NAV duration. In an embodiment, the AP may start a “MediumSyncDelay” timer for the medium synchronization duration of the ACH, after switching to the ACH. The “MediumSyncDelay” timer may be set based on the medium synchronization duration for the ACH indicated in.

In an embodiment, after switching to the ACH, the AP may be configured to transmit a frame 1606 on the ACH during the medium synchronization duration for the ACH. In an implementation, the AP may be capable of concurrent CS on the PCH and the ACH. Thus, as shown in FIG. 16, the AP may transmit frame 1606 on the ACH (after performing a random backoff) without waiting for expiration of the medium synchronization duration for the ACH. Frame 1606 may be any frame, including a CTS frame, a contention free (CF) end frame, a trigger frame, a QoS data/null frame, or a null data packet (NDP) frame.

In an implementation, the AP may determine a CCA state of the ACH before transmitting frame 1606. In an implementation, the AP may transmit frame 1606 on condition of the CCA state of the ACH being idle. In an implementation, the AP may transmit frame 1606 on condition of the CCA state of the ACH being idle for a minimum sensing duration. The minimum sensing duration may start from an end of a PPDU carrying frame 1602 transmitted on the PCH. Requiring that the ACH be idle for a minimum sensing duration before transmitting frame 1606 reduces the probability of frame 1606 interfering with “hidden” transmissions taking place on the ACH, i.e., transmissions that the AP was unable to detect on the ACH while transmitting frame 1602 on the PCH. In an implementation, the CCA state of the ACH being idle comprises a received power measured by the AP on the ACH, during the first duration, being less than a threshold. The minimum sensing duration may be one of 5.484 milliseconds, 25 microseconds, or 16 microseconds, for example. In an implementation, the value of the minimum sensing duration may be set to the “dot11MSDTimerDuration” value. The threshold may be one of −62 dBm, −72 dBm, or −82 dBm, for example. In an embodiment, the CCA state of the ACH being idle comprises a NAV associated with the ACH being equal to zero.

The transmission by the AP of frame 1606 allows a non-concurrent CCA MPC STA (associated with the AP) to acquire medium synchronization on the ACH. Specifically, on receiving frame 1606, the STA may reset a “MediumSyncDelay” timer to zero. The STA may then proceed to access the ACH, after performing a random backoff, to transmit a frame on the ACH.

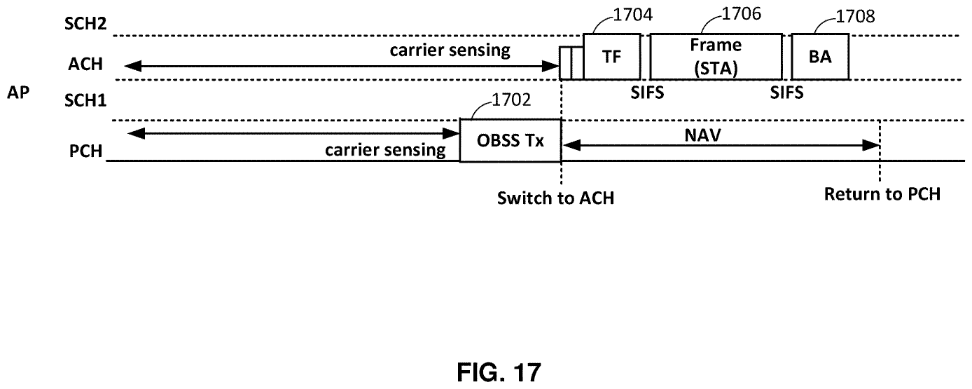

FIG. 17 illustrates another example procedure which may be performed by an AP according to an embodiment. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH. The AP may support an anchor/auxiliary primary channel medium synchronization assistance mode, which allows the AP to perform the procedure of FIG. 17. The example procedure of FIG. 17 may be used independently or in combination with the procedure of FIG. 15 and/or the procedure of FIG. 16.

As shown in FIG. 17, the example procedure may begin with the AP operating on the PCH. In an example, while the AP operates on the PCH, transmission of a frame 1702 from an OBSS may begin on the PCH. The AP may detect frame 1702 on the PCH. In an implementation, the AP may be configured to set a NAV associated with the PCH based on receiving frame 1702 on the PCH. Frame 1702 may indicate a transmission on the PCH. A duration of the transmission on the PCH may be provided by a duration field of frame 1702, a transmission opportunity (TXOP) duration field of a PPDU comprising frame 1702, or a length field of the PPDU. In an implementation, the AP may be configured to switch to the ACH for the NAV duration. In an embodiment, the AP may be configured not to start a “MediumSyncDelay” timer for the medium synchronization duration of the ACH, after switching to the ACH.

In an embodiment, after switching to the ACH, the AP may be configured to transmit a trigger frame 1704 on the ACH. Trigger frame 1704 may be addressed to one or more STA associated with the AP. In an implementation, the AP may transmit trigger frame 1704 on the ACH after performing a random backoff. As the AP does not start a “MediumSyncDelay” timer on switching to the ACH, the AP may transmit trigger frame 1704 without regard to a medium synchronization duration of the ACH.

In an implementation, the AP may determine a CCA state of the ACH before transmitting trigger frame 1704. In an implementation, the AP may transmit trigger frame 1704 on condition of the CCA state of the ACH being idle. In an implementation, the CCA state of the ACH being idle comprises a received power measured by the AP on the ACH, during a first duration, being less than a threshold. The first duration may be one of 5.484 milliseconds, 25 microseconds, or 16 microseconds, for example. The threshold may be one of −62 dBm, −72 dBm, or −82 dBm, for example. In an embodiment, the CCA state of the ACH being idle comprises a NAV associated with the ACH being equal to zero.

The transmission by the AP of trigger frame 1704 allows a non-concurrent CCA MPC STA (associated with the AP) to acquire medium synchronization on the ACH. The STA may be associated with the AP and may have switched to the ACH along with the AP. In an implementation, on receiving trigger frame 1704, the STA may reset to zero a “MediumSyncDelay” timer associated with the ACH. Further, trigger frame 1704 allows the STA to access the ACH in response to trigger frame 1704. That is, the STA may not need to perform a random backoff before attempting to access the ACH. Instead, as shown in FIG. 17, the STA may transmit a frame 1706 a short interframe space (SIFS) after trigger frame 1704, in response to trigger frame 1704. The AP may acknowledge frame 1706 by transmitting a BA frame 1708 to the STA.

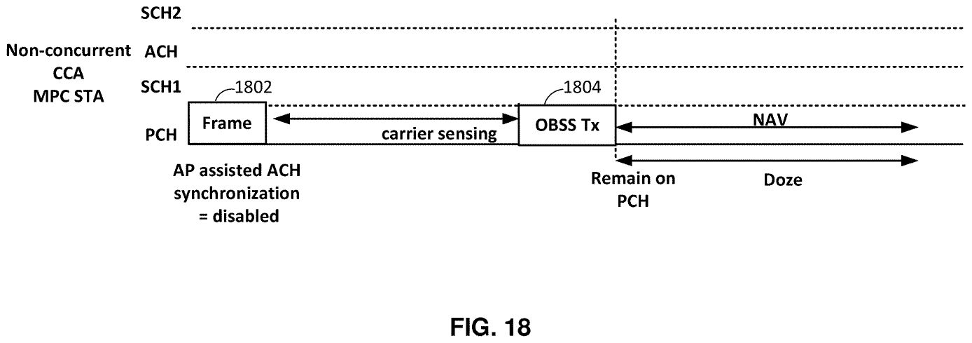

FIG. 18 illustrates an example procedure which may be performed by a STA according to an embodiment. The STA may be a non-concurrent CCA MPC STA. The STA may be associated with an AP. The AP may support an anchor/auxiliary primary channel medium synchronization assistance mode, which allows the AP to perform the procedure of FIG. 15, FIG. 16, and/or FIG. 17. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH. The example procedure of FIG. 18 may be used in combination with the procedure of FIG. 15, FIG. 16, and/or FIG. 17.

As shown in FIG. 18, the example procedure may begin with the STA operating on the PCH along with the AP. In an example, the STA may receive a frame 1802 transmitted by the AP on the PCH. Frame 1802 may be a management frame, such as a beacon frame. In an embodiment, frame 1802 may indicate the PCH and the ACH. In an embodiment, frame 1802 may comprise or indicate a medium synchronization duration for the ACH. In an embodiment, frame 1802 may comprise an indication of support by the AP of the anchor/auxiliary primary channel medium synchronization assistance mode. In an embodiment, frame 1802 may further comprise an indication of activation/deactivation by the AP of the anchor/auxiliary primary channel medium synchronization assistance mode.

In an example, while the STA is operating on the PCH, transmission of a frame 1804 from an OBSS may begin on the PCH. The STA may detect frame 1804 on the PCH. In an implementation, the STA may be configured to set a NAV associated with the PCH based on receiving frame 1804 on the PCH. Frame 1804 may indicate a transmission on the PCH. A duration of the transmission on the PCH may be provided by a duration field of frame 1804, a transmission opportunity (TXOP) duration field of a PPDU comprising frame 1804, or a length field of the PPDU.

In an embodiment, the STA may be configured to switch to the ACH after receiving frame 1804 on the PCH, on condition that the anchor/auxiliary primary channel medium synchronization assistance mode is activated by the AP in frame 1802. As such, as shown in FIG. 18, the STA may remain on the PCH after receiving frame 1804, when frame 1802 indicates that the anchor/auxiliary primary channel medium synchronization mode is deactivated. In an implementation, as the AP may switch to the ACH on receiving frame 1804, the STA may enter a doze state when the STA does not switch to the ACH along with the AP. In an implementation, the STA may enter the doze state for the duration of the NAV set based on receiving frame 1804.

In an implementation, when the STA switches to the ACH, i.e., when frame 1802 indicates that the anchor/auxiliary primary channel medium synchronization assistance mode is activated by the AP, the STA may be configured to switch to the ACH for the duration of the NAV set based on receiving frame 1804. In an embodiment, the AP may start a “MediumSyncDelay” timer for the medium synchronization duration of the ACH, after switching to the ACH. The “MediumSyncDelay” timer may be set based on the medium synchronization duration for the ACH indicated in frame 1804.

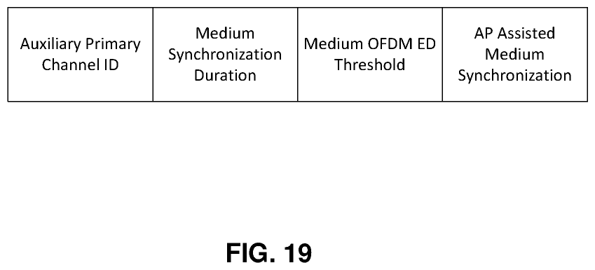

FIG. 19 illustrates an example information element which may be used in embodiments. The information element may be referred to as an “anchor channel element” or an “auxiliary primary channel element.” The information element may be used by an AP to inform an associated STA of medium synchronization information/parameters for an anchor/auxiliary primary channel. The information element may be carried in a MAC capabilities element of the AP.

As shown in FIG. 19, the information element may comprise an anchor/auxiliary primary channel ID field, a medium synchronization duration field, a medium OFDM ED threshold field, and an AP assisted medium synchronization field. The anchor/auxiliary primary channel ID field indicates an identifier of the anchor/auxiliary primary channel. The medium synchronization duration field indicates a duration of the medium synchronization duration (e.g., MediumSyncDelay timer) for the anchor/auxiliary primary channel. The medium synchronization duration may be indicated in units of 32 microseconds. The medium OFDM ED threshold field indicates a threshold value that may be used by a STA during medium synchronization recovery for the anchor/auxiliary primary channel. The AP assisted medium synchronization field indicates whether the AP supports a medium synchronization assistance mode for the anchor/auxiliary primary channel. Support of the medium synchronization assistance mode may comprise the AP supporting one or more of the procedures described in FIGS. 15-17 above.

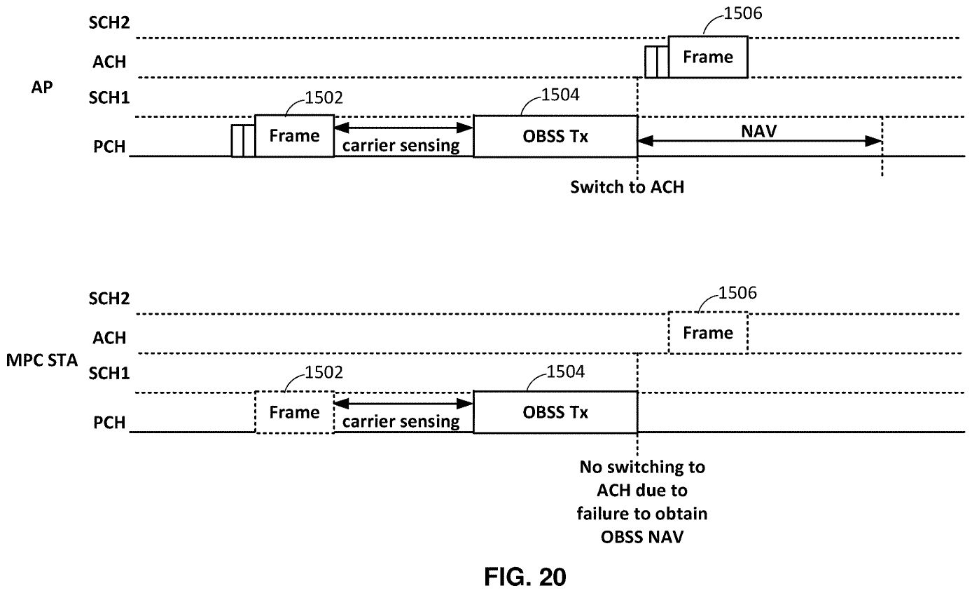

FIG. 20 illustrates an inefficiency that may arise in the procedure of FIG. 15. As shown in FIG. 20, in some scenarios, despite the STA being an MPC STA, the STA may not switch to the ACH after detecting frame 1504 on the PCH. This may be due to the STA being configured to switch to the ACH only when the STA is able to set the NAV on the PCH based on frame 1504. However, in some cases, the STA, while detecting frame 1504, may not be able to determine the NAV associated with frame 1504. For example, the TXOP field of the PPDU comprising frame 1504 may be set to “UNSPECIFIED” and the STA may fail to decode MPDU(s) of frame 1504 to obtain the TXOP duration. For example, frame 1504 may be transmitted using a higher modulation and coding scheme (MCS) that causes the STA to fail to decode the MPDU(s) of frame 1504. As such, the STA may remain on the PCH, while the AP switches to the ACH for the duration of the NAV that the AP sets based on frame 1504. The STA may thus be deprived from communication until the AP returns to the PCH at the end of the NAV duration.

To mitigate this potential problem, in embodiments, an MPC STA may be configured to switch to the ACH even when the MPC STA is unable to determine the TXOP duration/NAV associated with the OBSS frame (e.g., frame 1504). In an embodiment, the MPC STA may be configured to switch to the ACH based on a physical carrier sensing of the PCH indicating that the PCH is busy. In an embodiment, the MPC STA may be configured to switch to the ACH on detecting an OBSS frame on the PCH even if the MPC STA is unable to determine the TXOP duration/NAV associated with the OBSS frame. In an embodiment, detecting an OBSS frame may comprise receiving a signal field of a PPDU being received, where the signal field allows the MPC STA to determine that the PPDU comprises an OBSS frame. The signal field may be comprised in a PHY portion (e.g., PHY header) of the PPDU. For example, the signal field may be a universal signal (U-SIG) field of the PPDU. The U-SIG field may comprise a BSS color associated with an OBSS. In another embodiment, the MPC STA may be configured to switch to the ACH on failing to decode one or more MPDU of a PPDU being received on the PCH even if the MPC STA is unable to determine the TXOP duration/NAV associated with the PPDU. In an implementation, the MPC STA may be configured to switch to the ACH on failing to decode a first occurring MPDU (or a fixed number of first occurring MPDUs) of the PPDU. In another implementation, the MPC STA may be configured to switch to the ACH on failing to decode a delimiter of a first occurring MPDU of the PPDU.

With the MPC STA switching to the ACH without having determined the TXOP duration/NAV associated with the OBSS frame, the MPC STA may not have knowledge of the time at which the AP will return to the PCH. In an embodiment, after switching to the ACH, the AP may be configured to transmit on the ACH a frame that indicates a duration based on the TXOP duration/NAV associated with the OBSS frame. The duration may correspond to the TXOP duration or may overlap with the TXOP duration of the OBSS frame. In addition to allowing the MPC STA to recover medium synchronization on the ACH (without having to wait for expiration of the “MediumSyncDelay” timer), the frame transmitted by the AP informs the MPC STA of the time at which the MPC STA should return to the PCH. The MPC STA may thus communicate with the AP on the ACH and return, along with the AP, to the PCH when the transmission of the OBSS frame has ended on the PCH. Example procedures according to embodiments are further described below.

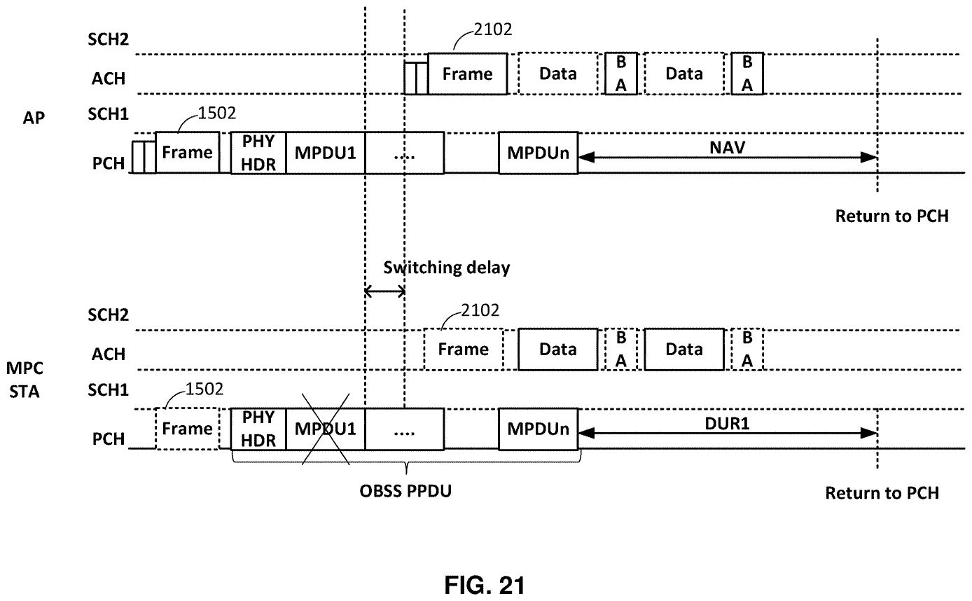

FIG. 21 illustrates an example procedure according to an embodiment. As shown in FIG. 21, the example procedure may include an AP and an MPC STA. The MPC STA may be associated with the AP. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH.

As shown in FIG. 21, the example procedure may begin with the AP operating on the PCH. In an example, the AP may transmit a frame 1502 on the PCH. Frame 1502 may be a management frame, such as a beacon frame, a probe response frame, an association response frame, or a fast initial link setup (FILS) frame. In an embodiment, frame 1502 may indicate the PCH and the ACH. In an embodiment, frame 1502 may comprise or indicate a medium synchronization duration for the ACH. In an embodiment, frame 1502 may comprise an indication of support by the AP of an anchor/auxiliary primary channel medium synchronization assistance mode. In an embodiment, frame 1502 may further comprise an indication of activation/deactivation of the anchor/auxiliary primary channel medium synchronization assistance mode by the AP. The STA, associated with the AP, may operate on the same channel as the AP. The STA may thus receive frame 1502 via the PCH.

In an example, while the AP is operating on the PCH, transmission of an OBSS (or inter-BSS) frame may begin on the PCH. The AP may detect the OBSS frame on the PCH. In an implementation, the AP may be configured to set a NAV associated with the PCH based on receiving the OBSS frame on the PCH. In an implementation, the OBSS frame may comprise a duration field that indicates a first duration. The duration field may be a TXOP field in a PHY header (or PHY preamble (e.g., extremely high throughput (EHT) preamble or ultra-high reliability (UHR) preamble) of the OBSS frame or a duration field in an MPDU of the OBSS frame. The first duration may comprise a time period for transmission or reception of one or more frames after the OBSS frame. In an implementation, the AP may be configured to set the NAV for the PCH based on the first duration. In an implementation, the NAV may be a basic NAV. In an implementation, the OBSS frame may comprise a field (e.g., BSS color field) that indicates that the OBSS frame is from an OBSS or an inter-BSS. In an implementation, the AP may be configured to switch to the ACH for the NAV duration. In an embodiment, the AP may (or may not) start a “MediumSyncDelay” timer for the medium synchronization duration of the ACH, after switching to the ACH. The “MediumSyncDelay” timer may be set based on the medium synchronization duration for the ACH indicated in frame 1502. In an implementation, the AP may be configured to switch to the ACH after decoding the PHY header and first occurring MPDU of the OBSS frame.

In an embodiment, after switching to the ACH, the AP may be configured to transmit a frame 2102 on the ACH during the medium synchronization duration for the ACH. In an implementation, the AP may be capable of concurrent CS on the PCH and the ACH. Thus, as shown in FIG. 21, the AP may transmit frame 2102 on the ACH (after performing a random backoff) without waiting for expiration of the medium synchronization duration for the ACH. In another implementation, the AP may wait for a switching delay after switching to the ACH before transmitting frame 2102. Frame 2102 may be any frame, including a CTS frame, a contention free (CF) end frame, a trigger frame, a control frame, an action frame, a management frame, a data frame, a QoS data/null frame, or a null data packet (NDP) frame.

In an embodiment, frame 2102 may indicate a second duration. The second duration may overlap with the first duration indicated in the OBSS frame. In an embodiment, the second duration may be based on the first duration. In an embodiment, the second duration may be shorter or longer than the first duration. In an implementation, a start time of the second duration may be later than a start time of the first duration. In an implementation, an end time of the second duration is same as an end time of the first duration. In an implementation, an end time of the second duration may be earlier or later than an end time of the first duration. In an embodiment, the second duration may indicate the TXOP duration indicated in the OBSS frame.

The MPC STA, associated with the AP, may also detect the OBSS frame on the PCH. In an embodiment, the MPC STA may receive a signal field of the OBSS frame, where the signal field allows the MPC STA to determine that the OBSS frame comprises an inter-BSS frame. The signal field may be comprised in a PHY portion (e.g., PHY header) of the OBSS frame. For example, the signal field may be a universal signal (U-SIG) field of the OBSS frame. The U-SIG field may comprise a BSS color associated with an OBSS.

In an example, the MPC STA may fail to determine the TXOP duration indicated in the OBSS frame. For example, a TXOP field of a PHY header (or PHY preamble (e.g., extremely high throughput (EHT) preamble or ultra-high reliability (UHR) preamble)) of the OBSS frame may be set to “UNSPECIFIED” and the MPC STA may fail to decode one or more MPDU (containing the TXOP duration) of the OBSS frame. In an embodiment, as discussed above, the MPC STA may be configured to switch to the ACH even when the MPC STA is unable to determine the TXOP duration/NAV associated with the OBSS frame. In an embodiment, the MPC STA may be configured to switch to the ACH based on a physical carrier sensing of the PCH indicating that the PCH is busy. In another embodiment, the MPC STA may be configured to switch to the ACH on failing to decode one or more MPDU of the OBSS frame being received on the PCH even if the MPC STA is unable to determine the TXOP duration/NAV associated with the OBSS frame. In an implementation, the MPC STA may be configured to switch to the ACH on failing to decode a first occurring MPDU (or a fixed number of first occurring MPDUs) of the OBSS frame. In another implementation, the MPC STA may be configured to switch to the ACH on failing to decode a delimiter of a first occurring MPDU of the OBSS frame. In an implementation, the MPC STA may start a “MediumSyncDelay” timer for the medium synchronization duration of the ACH, after switching to the ACH. The “MediumSyncDelay” timer may be set based on the medium synchronization duration for the ACH indicated in frame 1502.

In an example, as shown in FIG. 21, the MPC STA may be a non-concurrent CCA MPC STA. On switching to the ACH, the STA may not be aware of whether a transmission is taking place on the ACH. The STA may be configured to wait for the “MediumSyncDelay” timer to expire before attempting to access the ACH. The transmission by the AP of frame 2102, however, allows the non-concurrent CCA MPC STA to acquire medium synchronization on the ACH. Specifically, on receiving frame 2102, the STA may reset the “MediumSyncDelay” timer to zero. The STA may then proceed to access the ACH, after performing a random backoff, to transmit one or more data frames on the ACH. The AP may respond to the one or more data frames with one or more BA frames.

In an embodiment, the MPC STA may be configured to use the second duration indicated in frame 2102 to determine a time to return to the PCH. In another embodiment, the MPC STA may set a NAV for the PCH based on the second duration indicated in frame 2102. In an implementation, the MPC STA may set the NAV for the PCH based on the second duration indicated in frame 2102 and a length of the OBSS frame. In an implementation, the MPC STA may determine the length of the OBSS frame from an L-SIG field present in the PHY header of the OBSS frame. As shown in FIG. 21, the second duration (denoted “DUR1” in FIG. 21) may be appended to an end of the OBSS frame to set the NAV for the PCH.

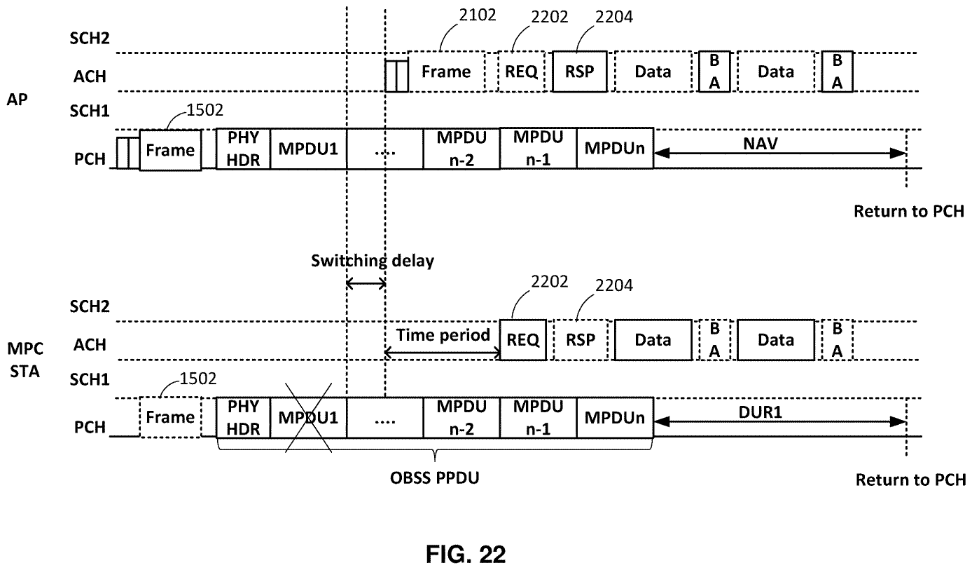

In some cases, the MPC STA may switch to the ACH as described above but may fail to obtain, via the ACH, the TXOP/NAV duration of the OBSS frame transmitted on the PCH. For example, the AP may fail to transmit frame 2102 described above due to the CCA state of the ACH being busy at the AP. Alternatively, the MPC STA may fail to decode frame 2102. In an embodiment, as illustrated in FIG. 22, the MPC STA may be configured to transmit to the AP a frame 2202 requesting the second duration from the AP. In an embodiment, the MPC STA may be configured to transmit frame 2202 in response to not obtaining the TXOP/NAV duration of the OBSS frame within a pre-defined time period from switching to the ACH. The failure to obtain the TXOP/NAV duration of the OBSS frame may be due to the MPC STA not receiving or failing to decode a frame (e.g., frame 2102) from the AP indicating the TXOP/NAV duration of the OBSS frame. In an embodiment, the pre-defined time period may be based on or equal to the “MediumSyncDelay” timer of the ACH. Frame 2202 may be a control frame, a management frame, an action, or a QoS null/data frame.

In an embodiment, the AP may be configured to transmit a frame 2204 in response to frame 2202 from the MPC STA. Frame 2204 may comprise or indicate the second duration as described above. Frame 2204 may be a control frame, a management frame, an action, or a QoS null/data frame. In an embodiment, the MPC STA may be configured to use the second duration indicated in frame 2204 to determine a time to return to the PCH. In another embodiment, the MPC STA may set a NAV for the PCH based on the second duration indicated in frame 2204. In an implementation, the MPC STA may set the NAV for the PCH based on the second duration indicated in frame 2204 and a length of the OBSS frame. In an implementation, the MPC STA may determine the length of the OBSS frame from an L-SIG field present in the PHY header of the OBSS frame. As shown in FIG. 22, the second duration (denoted “DUR1” in FIG. 22 may be appended to an end of the OBSS frame to set the NAV for the PCH.

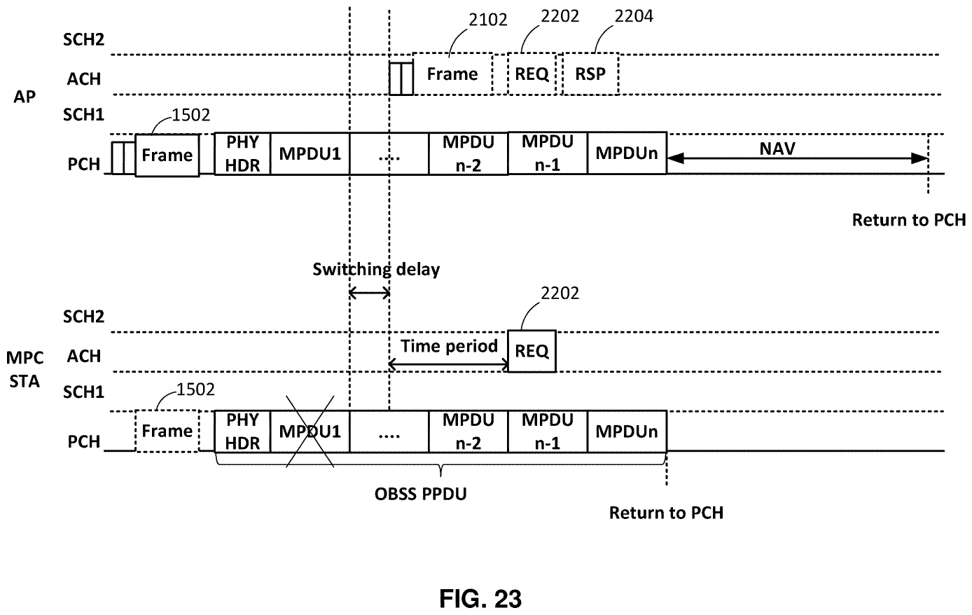

In some cases, the MPC STA may fail to receive frame 2204 from the AP in response to frame 2202. For example, the AP may not transmit frame 2204. For example, the AP may not receive frame 2202 from the MPC STA or the AP may not be able to transmit frame 2204 due to the CCA state of the ACH being busy at the AP. In another example, the AP may transmit frame 2204 but the STA may fail to receive or decode frame 2204. In an embodiment, as illustrated in FIG. 23, the MPC STA may be configured to return to the PCH in response to not receiving a response (e.g., frame 2204) in response to a frame (e.g., frame 2202) requesting the second duration from the AP. The MPC STA may return to the PCH at, before, or after the end of the OBSS frame. In an implementation, the MPC STA may determine the length of the OBSS frame from an L-SIG field present in the PHY header of the OBSS frame. The MPC STA may determine the end of the OBSS frame based on the length of the OBSS frame.

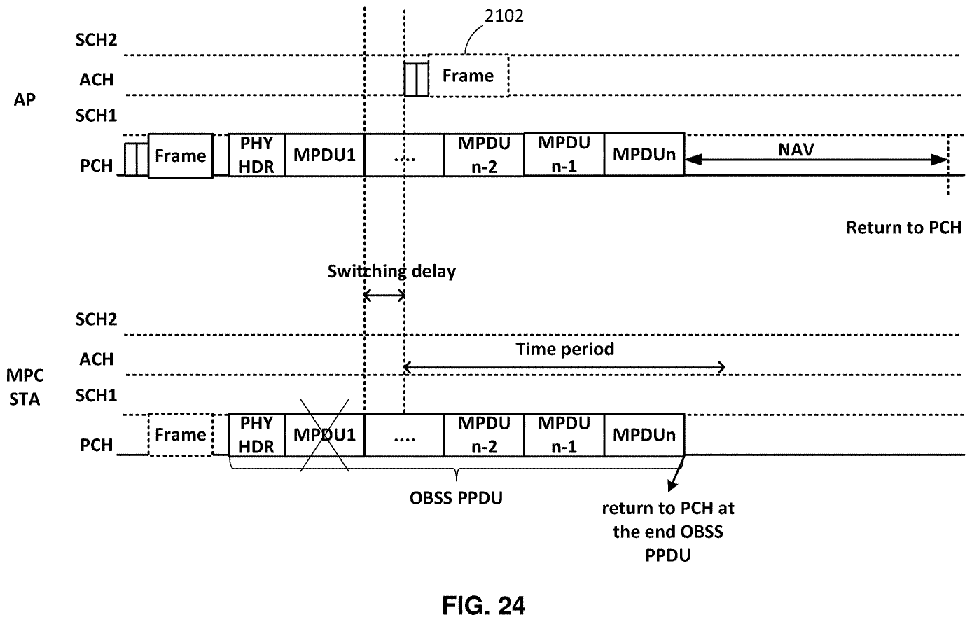

In another embodiment, as illustrated in FIG. 24, the MPC STA may be configured, after switching to the ACH, to return to the PCH if the MPC STA does not obtain the TXOP/NAV duration of the PCH before an end of the OBSS frame. For example, as shown in FIG. 24, the MPC STA may not receive frame 2102 indicating the second duration from the AP. The MPC STA may be configured to transmit a frame requesting the second duration from the AP in response to not obtaining the TXOP/NAV duration of the OBSS frame within a pre-defined time period from switching to the ACH. However, with the end of the OBSS frame occurring before the expiration of the pre-defined time period, the MPC STA may return to the PCH at the end of the OBSS frame, without transmitting a frame requesting the second duration from the AP.

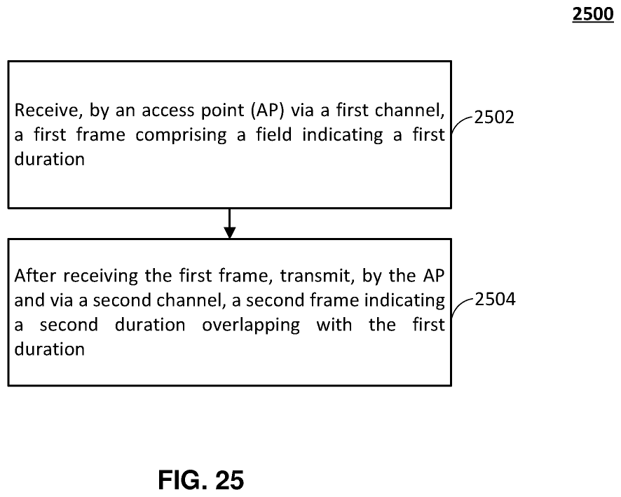

FIG. 25 illustrates an example process 2500 according to an embodiment. Example process 2500 may be performed by an AP. The AP may operate over a plurality of channels. The plurality of channels may include a primary channel and an anchor/auxiliary primary channel. The plurality of channels may further include one or more secondary channels. The AP may be capable of performing concurrent CS on the primary channel and the anchor/auxiliary primary channel. The AP may support an anchor/auxiliary primary channel medium synchronization assistance mode, which allows the AP to perform one or more of the procedures of FIGS. 15, 16, 17, 21, and 22. As shown in FIG. 25, process 2500 may include steps 2502 and 2504.

Step 2502 includes receiving, by the AP via a first channel, a first frame comprising a field indicating a first duration. In an embodiment, the first channel comprises the primary channel of the AP. For example, the primary channel may be a primary 20 MHz channel of the AP. In an embodiment, the field comprises a duration field of the first frame. In an embodiment, the duration field comprises or indicates a time period for transmission or reception of one or more frames on the first channel after the first frame. For example, the field may be a TXOP field present in a PHY header (or PHY preamble (e.g., extremely high throughput (EHT) preamble or ultra-high reliability (UHR) preamble)) of a physical protocol data unit (PPDU) comprising the first frame. In an example, the TXOP field may be present in a universal signal (U-SIG) of the PHY header. In another example, the field may be a Duration field present in a MAC header (of one or more MPDU) of the first frame. The first frame may be a control frame, a management frame, an action frame, or a QoS data/null frame.

In an embodiment, the first frame may be transmitted by a STA or an AP in an OBSS. The first frame may thus be an OBSS (or inter-BSS) frame. In an embodiment, the first frame may comprise a BSS color field. In an embodiment, the BSS color field indicates an OBSS relative to the AP.

Step 2504 includes, after receiving the first frame, transmitting, by the AP and via a second channel, a second frame indicating a second duration. In an embodiment, the second channel comprises a non-primary channel of the AP. In an embodiment, the second channel comprises an anchor/auxiliary primary channel of the AP. In an example, the second channel comprises a 20 MHz channel other than the primary 20 MHz channel of the AP. The second frame may be a control frame, a management frame, an action frame, or a QoS data/null frame.

The second duration may overlap with the first duration indicated in the first frame. In an embodiment, the second duration may be based on the first duration. In an embodiment, the second duration may be shorter or longer than the first duration. In an implementation, a start time of the second duration may be later than a start time of the first duration. In an implementation, an end time of the second duration is same as an end time of the first duration. In an implementation, an end time of the second duration may be earlier or later than an end time of the first duration. In an embodiment, the second duration may indicate the TXOP duration indicated in the OBSS frame.

In an embodiment, process 2500 may further comprise transmitting, by the AP, a third frame comprising a medium synchronization duration for the second channel. The third frame may be a beacon frame, a probe response frame, an association response frame, or a FILS frame.

In an embodiment, step 2504 may comprise transmitting, by the AP, the second frame during the medium synchronization duration for the second channel.

In an embodiment, process 2500 may further comprise receiving, by the AP from a STA via the second channel, a fourth frame requesting the second frame. In an embodiment, process 2500 may further comprise transmitting, by the AP to the STA, the second frame in response to the fourth frame. The fourth frame may be a control frame, a management frame, an action frame, or a QoS data/null frame.

In an embodiment, process 2500 may further comprise transmitting/receiving, by the AP to/from a STA via the second channel, one or more frames during the second duration.

In an embodiment, process 2500 may further comprise, before step 2502, transmitting, by the AP, a fifth frame indicating: support of full CCA capability on the first channel and the second channel; and/or support of capability to switch to the second channel on condition of detecting an OBSS/inter-BSS PPDU on the first channel. The fifth frame may be a beacon frame, a probe response frame, an association response frame, or a FILS frame.

In an embodiment, process 2500 may further comprise receiving, by the AP from a STA, a sixth frame indicating a capability of contention-based transmission on the second channel; and transmitting, by the AP to the STA, the fifth frame in response to the sixth frame. The sixth frame may be a probe request frame, or an association request frame.

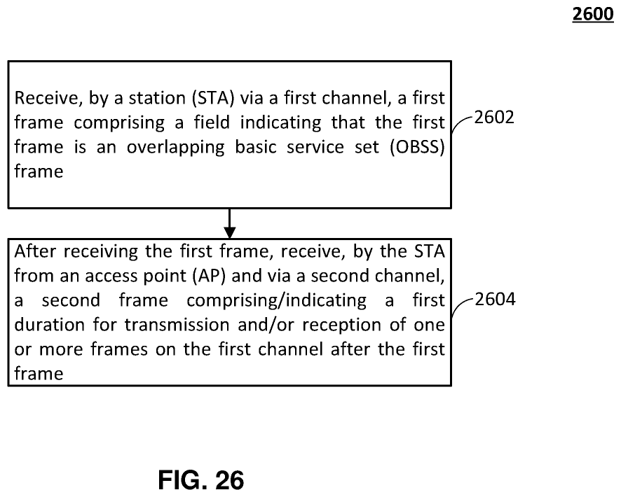

FIG. 26 illustrates another example process 2600 according to an embodiment. Example process 2600 may be performed by a STA. The STA may be an MPC STA. The STA may be associated with an AP. The plurality of channels may include a primary channel and an anchor/auxiliary primary channel. The plurality of channels may further include one or more secondary channels. The AP may be capable of performing concurrent CS on the first channel and the second channel. The AP may support a medium synchronization assistance mode for the first channel and/or the second channel. The AP may support an anchor/auxiliary primary channel medium synchronization assistance mode, which allows the AP to perform one or more of the procedures of FIGS. 15, 16, 17, 21, and 22. As shown in FIG. 26, process 2600 may include steps 2602 and 2604.

Step 2602 includes receiving, by the STA via the first channel, a first frame comprising a field indicating that the first frame is an OBSS frame. In an embodiment, the first channel comprises the primary channel of the AP/STA. For example, the primary channel may be a primary 20 MHz channel of the AP/STA.

In an embodiment, the field may be a BSS color field. The BSS color field may indicate an OBSS relative to the AP/STA or an inter-BSS relative to the AP/STA. In an embodiment, the BSS color field may be provided in a U-SIG field on a PPDU comprising the first frame. In an embodiment, the STA may decode the BSS color field to determine that the first frame is an OBSS frame (or inter-BSS frame) or intra-BSS frame.

In an embodiment, the first frame may further comprise a field indicating a second duration. In an embodiment, the field comprises a duration field of the first frame. In an embodiment, the duration field comprises or indicates a time period for transmission or reception of one or more frames on the first channel after the first frame. That is, the duration field indicates a time period, after the first frame, during which the first channel is expected to be busy. For example, the field may be a TXOP field present in a PHY header (a preamble (e.g., EHT preamble or UHR preamble) of a PPDU comprising the first frame. In another example, the field may be a Duration field present in a MAC header (of one or more MPDU) of the first frame. The first frame may be a control frame, a management frame, an action frame, or a QoS data/null frame.

In an embodiment, the STA may fail to obtain the second duration indicated in the field or the field may indicate an “UNSPECIFIED” value. In an embodiment, the STA may be configured to switch to the second channel even when the STA is unable to determine the second duration indicated in the first frame. In an embodiment, the second channel may be an anchor/auxiliary primary channel of the AP/STA. In an example, the second channel comprises a 20 MHz channel other than the primary 20 MHz channel of the AP. In an implementation, the STA may start a “Medium SyncDelay” timer for the medium synchronization duration of the second channel, after switching to the second channel.

Step 2604 includes, after receiving the first frame, receiving, by the STA from the AP and via the second channel, a second frame comprising/indicating a first duration. The first duration may be a duration for transmission and/or reception of one or more frames, after the first frame, on the first channel. That is, the first duration may represent a time period, after the first frame, during which the first channel is expected to be busy. The second frame may be a control frame, a management frame, an action frame, or a QoS data/null frame.

The first duration may overlap with the second duration indicated in the first frame. In an embodiment, the first duration may be based on the second duration. In an embodiment, the first duration may be shorter or longer than the second duration. In an implementation, a start time of the first duration may be later than a start time of the second duration. In an implementation, an end time of the first duration is same as an end time of the second duration. In an implementation, an end time of the second duration may be earlier or later than an end time of the first duration. In an embodiment, the first duration may indicate a TXOP duration indicated in the first frame.

In an embodiment, process 2600 may further comprise receiving, by the STA from the AP, a third frame comprising a medium synchronization duration for the second channel. The third frame may be a beacon frame, a probe response frame, an association response frame, or a FILS frame. In an embodiment, step 2604 may further comprise receiving, by the STA, the second frame during the medium synchronization duration.

In an embodiment, process 2600 may further comprise transmitting, by the STA to the AP via the second channel, a fourth frame requesting the second frame; and receiving, by the STA from the AP, the second frame in response to the fourth frame. The fourth frame may be a control frame, a management frame, an action frame, or a QoS data/null frame.

In an embodiment, process 2600 may further comprise transmitting/receiving, by the STA to/from the AP via the second channel, one or more frames during the second duration.

In an embodiment, process 2600 may further comprise switching, by the STA, to the second channel based on receiving the first frame. In another embodiment, process 2600 may further comprise switching, by the STA, to the second channel after receiving a first signal field of the first frame. In an embodiment, the first signal field may be a U-SIG field of a PPDU comprising the first frame. In an embodiment, the U-SIG field indicates that the first frame is an OBSS frame (or Inter-BSS frame). In another embodiment, process 2600 may further comprise switching, by the STA, to the second channel after decoding a first MPDU of the first frame. In another embodiment, process 2600 may further comprise switching, by the STA, to the second channel after decoding a first MPDU delimiter of the first frame.

In an embodiment, process 2600 may further comprise transmitting, by the STA to the AP, a frame indicating support of a capability to switch to the second channel on condition of detecting an OBSS or inter-BSS PPDU on the first channel.

In an embodiment, process 2600 may further comprise receiving, by the STA from the AP, a fifth frame indicating: support of full CCA capability on the first channel and the second channel; and/or support of a capability to switch to the second channel on condition of detecting an OBSS or inter-BSS PPDU on the first channel. The fifth frame may be a probe response frame, or an association response frame, a beacon frame, or a FILS discovery frame.

In an embodiment, process 2600 may further comprise transmitting, by the STA to the AP, a sixth frame indicating a capability of contention-based transmission on the second channel; and receiving, by the STA from the AP, the fifth frame in response to the sixth frame. The sixth frame may be a probe request frame, or an association request frame.

What is claimed is:

1. An access point (AP) comprising:
one or more processors; and
memory storing instructions that, when executed by the one or more processors, cause the AP to:
receive, via a first channel, a first frame comprising a field indicating a first duration; and
after receiving the first frame, transmit, via a second channel, a second frame indicating a second duration overlapping with the first duration.

2. The AP of claim 1, wherein the first channel comprises a primary channel of the AP.

3. The AP of claim 2, wherein the second channel comprises a non-primary channel of the AP.

4. The AP of claim 3, wherein the first duration comprises a time period for transmission or reception of one or more frames on the first channel after the first frame.

5. The AP of claim 4, wherein the second duration is based on the first duration.

6. The AP of claim 5, wherein the second duration is shorter than the first duration.

7. The AP of claim 6, wherein an end time of the first duration is later than an end time of the second duration.

8. The AP of claim 7, wherein the first frame is transmitted by a station (STA) or an AP in an overlapping basic service set (OBSS) or an inter-BSS.

9. The AP of claim 8, wherein the second frame is a control frame, a management frame, an action frame, or a quality of service (QoS) data/null frame.

10. The AP of claim 9, the instructions further causing the AP to:
receive, from the STA via the second channel, a third frame requesting the second frame comprising the second duration; and
transmit, to the STA, the second frame in response to the third frame.

11. The AP of claim 10, wherein the third frame is a control frame, a management frame, an action frame, or a quality of service (QoS) data/null frame.

12. A station (STA) comprising:
one or more processors; and
memory storing instructions that, when executed by the one or more processors, cause the STA to:
receive, via a first channel, a first frame comprising a field indicating that the first frame is an overlapping basic service set (OBSS) frame; and
after receiving the first frame, receive, from an access point (AP) and via a second channel, a second frame comprising a first duration for transmission and reception of one or more frames on the first channel after the first frame.

13. The STA of claim 12, wherein the first channel comprises a primary channel of the AP.

14. The STA of claim 13, wherein the second channel comprises a non-primary channel of the AP.

15. The STA of claim 12, wherein the first frame comprises a duration field indicating a second duration.

16. The STA of claim 15, wherein the first duration overlaps with the second duration.

17. The STA of claim 16, wherein the second frame is a control frame, a management frame, an action frame, or a quality of service (QoS) data/null frame.

18. The STA of claim 15, the instructions further causing the STA to transmit and receive, to/from the AP via the second channel, one or more frames during the second duration.

19. The STA of claim 18, the instructions further causing the STA to switch to the second channel based on receiving the first frame.

20. A non-transitory computer-readable medium comprising instructions that, when executed by one or more processors of an access point (AP), cause the AP to:
receive, via a first channel, a first frame comprising a field indicating a first duration; and
after receiving the first frame, transmit, via a second channel, a second frame indicating a second duration overlapping with the first duration.
